(19) United States
(12) Patent Application Publication
(10) Pub. No.: US 2014/0343744 A1
(43) Pub. Date: Nov. 20, 2014

(54) AUTONOMOUS SMART GRID DEMAND MEASUREMENT SYSTEM AND METHOD

(71) Applicant: The Powerwise Group Inc., Boca Raton, FL (US)

(72) Inventors: Stephen Kenneth Mansfield, Wellington, FL (US); Donald Jay McDonald, Boca Raton, FL (US)

(21) Appl. No.: 14/211,746

(22) Filed: Mar. 14, 2014

Related U.S. Application Data
(60) Provisional application No. 61/781,822, filed on Mar. 14, 2013.

(51) Int. Cl. G05F 1/66

(52) U.S. Cl. CPC G05F 1/66
USPC 700/297

(57) ABSTRACT

An energy savings device, system and method are provided to improve electric utility grid stability by reducing power demand at a point of consumption. The method may include monitoring a power signal characteristic, obtaining a stability parameter for the utility grid, determining a stability condition based on the monitored power signal characteristic and the stability parameter; and regulating, at the point of consumption, an amount of energy received from the utility grid based on the determined stability condition. The system may include an energy savings system in communication with the electric utility grid and a processor and non-transitory computer-readable medium configured to perform the method.

### CROSS REFERENCE TO RELATED APPLICATIONS

This application claims priority to U.S. Provisional Application No. 61/781,822 filed on Mar. 14, 2013, the complete disclosure of which is incorporated herein by reference.

### BACKGROUND OF THE DISCLOSURE

1. Field of the Disclosure

This disclosure generally relates to the field of electrical energy savings, and, in particular, energy savings involving voltage regulation.

2. Description of the Art

Since the industrial revolution, the world's consumption of energy has grown at a steady rate. Most power generated and energy consumed is from the combustion of fossil fuels, a nonrenewable natural resource that is rapidly becoming depleted. As the depletion of Earth's natural resources continues and the costs for such resources rapidly increase, power generation and energy conservation has become an increasingly important issue with governments, businesses, and consumers.

In addition to general concerns with power generation and energy conservation, there also exist concerns with power distribution, especially in emerging economies. The problem of power distribution is of great concern as it involves existing infrastructure that is usually inadequate for properly distributing power and not readily suitable to be improved upon. This problematical situation is manifested by “brown outs” wherein a nominal AC voltage cannot be maintained in the face of a grid/generation overload.

Currently, governmental entities and power companies attempt to remedy brown out occurrences by elevating the alternating current (“AC”) voltage or adding power shedding generation at appropriate locations on the power grid. This method usually results in a wide disparity of voltages available to consumers in homes and/or business. For example, the voltage increases may range from ten percent to fifteen percent (10%-15%). Since power is calculated by Voltage²/load, the result of the governmental entities' and power companies' “remedy” can result in increased charges of up to twenty-five percent (25%) to consumers. Thus, rather than conserving energy, governmental entities and power companies are expending energy.

Typically, electric power is defined as,

Pᵢₙ=Vᵢₙ×Aᵢₙ (1)

The total power consumed by an appliance may be calculated as the input voltage multiplied by the input current. Most appliances are designed to operate at an optimum voltage. If the line voltage obtained from the grid is higher than the optimum voltage for an appliance, then the appliance will shed the excess power as heat. Shedding power as heat results in wasted energy that is paid for by the customer. By contrast, if the voltage is significantly less than the optimum voltage, then the appliance may not work properly.

Single phase devices are often designed with an optimum voltage for efficient operation. For example, in the United States, the optimum voltage for single phase devices is usually 115V. However, electric utilities often boost the distribution voltage to a higher voltage in order to compensate for line voltage losses. This boosted distribution voltage may be required because the line voltage losses in the regional or neighborhood distribution grid may result in a line voltage below 115V at the point of use.

In a region or neighborhood located closest to a transformer, the voltage may be boosted to 125V to 140V, for example. At an end of the distribution grid, such as a location farthest from a transformer, line losses may reduce the voltage to just 115V or below. If the grid voltage is not boosted at the transformer or at the beginning of the distribution grid, the voltage may be too low at the end of the grid to properly power customer appliances.

When providing electric power, electric utility operators continuously monitor electric grid power stability to maintain reliable electric power delivery. For example, electric utilities principally monitor three electric grid power stability parameters to determine a health of the network: 1) Rotor Stability, 2) Grid Frequency Stability, and 3) Grid Voltage Stability.

Electric utilities typically employ specific stability regions that are defined for determining electric grid power stability. If an electric grid becomes unstable, the electric power utility may lose control of the electric grid and the ability to reliably deliver electric power. When an electric grid power becomes unstable, the electric utility generally only has three practical corrective options: 1) repair the instability, 2) increase power generation, or 3) reduce power demand. The magnitude of the instability and the speed at which an electric utility can implement each of the above corrective options determine whether or not a failure in the electric grid will occur. A failure may include a brown-out, a rolling black-out, or a complete electric grid power failure. In general, an electric grid can handle small transient or long term instabilities. However, larger instabilities are problematic and can cause the electric grid to fail.

While electric grid failures can be avoided by reducing the load on the grid, the electric utility has little control over individual consumer demands on the grid. Attempts to regulate consumer demand that focus on individual electric devices (motors, appliances, lights sources) in a home or business can be expensive and complicated. Therefore, a need exists for reducing the probability of electric grid failures where energy demand reduction is performed at a consumer demand level without managing individual electric devices.

### BRIEF SUMMARY OF THE DISCLOSURE

In aspects, the present disclosure is related to improving electric utility grid power stability. Specifically, the present disclosure is related to improving electric utility grid power stability using a probability model and an energy savings system with IGBT/FET devices configured to regulate voltage at a point of energy consumption.

One example includes a method of reducing power demand on an electric utility grid at the point of consumption that includes monitoring a power signal characteristic, obtaining a stability parameter for the utility grid, determining a stability condition based on the monitored power signal characteristic and the stability parameter; and regulating, at the point of consumption, an amount of energy received from the utility grid based on the determined stability condition.

The power signal characteristic and the stability parameter may be used to determine a rotor angle stability probability of failure. The rotor angle stability probability of failure may include a small angle rotor stability, a transient rotor angle stability, and a short term rotor angle stability over time. The rotor angle stability probability of failure may be estimated based on the angle rotor stability, the transient rotor angle stability, and the short term rotor angle stability over time. The rotor angle stability probability of failure may be estimated using an algorithm including one or more of: i) statistical averaging, ii) statistical time state averaging, iii) a stochastic differential methodology, iv) curve fitting, and v) a pattern table look up of a pattern of the rotor phase angle.

The power signal characteristic and the stability parameter may be used to determine a grid frequency stability probability of failure. The grid frequency stability probability of failure may include a short term frequency stability and a long term frequency stability over time. The grid frequency stability probability of failure may be estimated based on the short term frequency stability and the long term frequency stability over time. The grid frequency stability probability of failure may be estimated using an algorithm including one or more of: i) statistical averaging, ii) statistical time state averaging, iii) a stochastic differential methodology, iv) curve fitting, and v) a pattern table look up of a pattern of the frequency.

The power signal characteristic and the stability parameter may be used to determine a grid voltage stability probability of failure. The grid voltage stability probability of failure may include a short term voltage stability and a long term voltage stability over time. The grid voltage stability probability of failure may be based on the short term voltage stability and the long term voltage stability over time. The grid voltage stability probability of failure may be estimated using: an algorithm including one or more of: i) statistical averaging, ii) statistical time state averaging, iii) a stochastic differential methodology, iv) curve fitting, and v) a pattern table look up of a pattern of the voltage.

The power or energy signal characteristics may include one or more of: voltage, voltage variation, frequency, frequency variation, and rotor stator angle harmonics. The power or energy signal characteristics may be obtained by an the energy savings system or a separate processor. The power or energy signal characteristics may be obtained at a power consumer location. Regulation of the amount of energy received from the electric utility grid may be based on a combination of at least one probability of electric utility grid power failure and at least one constant. The at least one probability of electric utility grid power failure may comprise two or more different probabilities of electric utility grid power failure, and the power regulation signal may be based on addition of the two or more different probabilities of electric utility grid power failure. The two or more different probabilities of electric utility grid power failure may be weighted or unweighted. An electric utility grid power stability condition may be derived from one or more of: rotor angle stability, grid frequency stability, and grid voltage stability. The power regulation algorithm may be based on at least one electric utility grid power stability condition.

Another examples includes an energy savings system for reducing power demand on a utility grid at a point of consumption, that includes a memory; and a processor that communicates with the memory having instructions stored thereon that, when executed by the processor, cause the system to monitor a power signal characteristic, obtaining a stability parameter for the utility grid, determining a stability condition based on the monitored power signal characteristic and the stability parameter; and regulating, at the point of consumption, an amount of energy received from the utility grid based on the determined stability condition.

Another embodiment includes a non-transitory computer-readable storage medium having stored therein instructions that, when executed by an processor, cause an electronic device to use pre-set stability parameters for the utility grid such that the energy savings device instantaneously measures the grid stability and compares these values to the pre-set grid stability states or conditions. If these pre-set parameters are exceeded a pre-determined amount of energy received from the utility grid is regulated at the point of consumption. This regulation remains until the utility grid returns to a more stable state. The computer-readable storage medium may include one or more of a flash drive, an EPROM, a hard disk, and a solid state memory device, or the like.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1A illustrates a partial block diagram of an IGBT/FET-based device and system of the present disclosure for use in a three-phase electrical system;

FIG. 1B illustrates a partial block diagram of an IGBT/FET-based device and system of the present disclosure for use in a three-phase electrical system;

FIG. 2 illustrates perspective plan view of a sensing device of the present disclosure;

FIG. 3 illustrates a circuit diagram of a sensing device of the present disclosure;

FIG. 4 illustrates a circuit diagram of a signal conditioning device of the present disclosure;

FIG. 5 illustrates an oscillogram for a volts zero crossing point determining device of the present disclosure;

FIG. 6 illustrates a circuit diagram for a volts zero crossing point determining device of the present disclosure;

FIG. 7 illustrates circuit diagram of a loss detecting device and phase rotation determination and rotating devices of the present disclosure;

FIG. 8 illustrates a circuit diagram of a half cycle identifying device of the present disclosure;

FIG. 9 illustrates an oscillogram of a half cycle identifying device of the present disclosure;

FIG. 10 illustrates an oscillogram of a half cycle identifying device of the present disclosure;

FIG. 11A illustrates a circuit diagram of the routing device of the present disclosure;

FIG. 11B illustrates a continuation of the circuit diagram of FIG. 11A;

FIG. 11C illustrates a circuit diagram of a ports programmer of FIGS. 11A and 11B;

FIG. 11D illustrates a circuit diagram of a resistor support of FIGS. 11A and 11B;

FIG. 11E illustrates a circuit diagram of a connector of FIGS. 11A and 11B;

FIG. 12A illustrates an oscillogram of a voltage reducing device of the present disclosure;

FIG. 12B illustrates an oscillogram of a voltage reducing device of the IGBT-based present disclosure;

FIG. 12C illustrates a circuit diagram of an IGBT-based voltage reducing device of the present disclosure;

FIG. 12D illustrates a circuit diagram of a drive circuitry for the IGBT-based voltage reducing device of FIG. 12C;

FIG. 12E illustrates a oscillogram of a voltage reducing device of the FET-based present disclosure;

FIG. 12F illustrates a circuit diagram of a FET-based voltage reducing device of the present disclosure;

FIG. 12G illustrates a circuit diagram of a drive circuitry for the FET-based voltage reducing device of FIG. 12F;

FIG. 13 illustrates a circuit diagram of a combined resetting device and indicator device of the present disclosure;

FIG. 14A illustrates a circuit diagram of a power supply unit of a powering device of the present disclosure;

FIG. 14B illustrates a circuit diagram of a power supply unit of a powering device of the present disclosure;

FIG. 15A illustrates a circuit diagram a communication device of the present disclosure;

FIG. 15B illustrates a circuit diagram of a USB interface of a communications device of FIG. 15A;

FIG. 15C illustrates a circuit diagram of an isolator block of a communications device of FIG. 15A;

FIG. 15D illustrates a circuit diagram of a first connector of a communications device of FIG. 15A into a digital signal processor;

FIG. 15E illustrates a circuit diagram of a second connector of a communications device of FIG. 15A;

FIG. 16 illustrates a screen shot of a windows interface of the present disclosure;

FIG. 17 illustrates a screen shot of a windows interface of the present disclosure;

FIG. 18 illustrates a system diagram of an energy reduction system based on electric utility grid stability according to one example of the present disclosure;

FIG. 19 illustrates a flow chart of a method to improve electric utility grid stability through local power reduction according one example of the present disclosure;

FIG. 20 illustrates a graph of a curve relating power regulation to grid stability according to one example of the present disclosure; and

FIG. 21 illustrates a graph of the restoration of power after a shutdown of the electric utility grid over time according to one example of the present disclosure.

### DETAILED DESCRIPTION OF THE DISCLOSURE

Various examples are provided herein. While specific examples are discussed, it should be understood that this is for illustration purposes only. A person skilled in the relevant art will recognize that other components and configurations may be used without departing from the spirit of the disclosure.

Systems and method are provided for improving electric utility grid power stability. In one example, systems and method are provided for improving electric utility power grid stability by employing a probability model that is implemented by an energy savings device. In one example, the energy savings system uses IGBT/FET devices that are configured to regulate voltage. Furthermore, an insulated gate bipolar transistor/field effect transistor (IGBT/FET) based energy savings device is provided for conserving energy while improving electric utility power grid stability.

According to one example, self-regulating or autonomous energy savings devices are provided at points of use, such as residential or commercial buildings. The autonomous energy savings devices may be programmed to monitor characteristics associated with an incoming energy or power signal obtained from an electrically coupled power grid and corresponding power generators, among other power grid components. The power signal characteristics may include, for example, frequency, voltage, and rotor angle, among other power grid characteristics. The power signal characteristics may differ for different countries, for different regions within a country, and for different areas of a power grid within a selected region of a country. For example, in a select region within the United States, a line voltage value may be 115V, a line frequency value may be 60 Hz, and a power generator rotor angle may be 3 degrees.

According to one example, the autonomous energy savings devices may be programmed to obtain instantaneous or real-time values for frequency, voltage, and rotor angle. Alternatively, the autonomous energy savings devices may be programmed to obtain average values obtained over a selected amount of time for frequency, voltage, and rotor angle. One of ordinary skill in the art will readily appreciate that other types of values may be obtained for frequency, voltage, and rotor angle.

The autonomous energy savings devices may be programmed to perform selected operations based on values associated with the power grid characteristics. For example, the autonomous energy savings devices may be programmed to match energy demand with energy supply provided by the electric utility power grid. According to one example, the autonomous energy savings devices may be programmed to match energy demand by regulating voltage values at individual points of consumption.

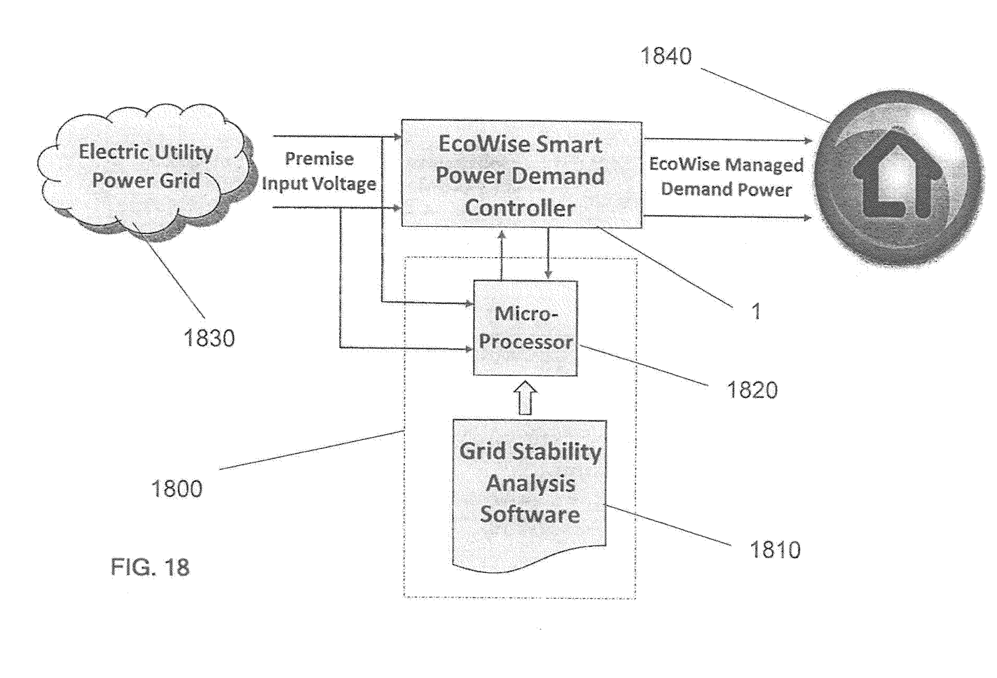

As discussed below with reference to FIGS. 18-21, the autonomous energy savings devices may monitor instantaneous power signal characteristics for variations in voltage values, frequency values, or rotor angle values. If the power signal characteristics indicate that the electric utility power grid is operating under normal conditions, then the autonomous energy savings device may boost or buck the line voltage to obtain a desired voltage value. If the power signal characteristics indicate that the electric utility power grid is operating under unstable conditions, then the autonomous energy savings device may automatically perform a first set of actions, such as lowering a voltage by a first pre-set amount. If the power signal characteristics indicate that the electric utility power grid is operating under chaotic conditions, then the autonomous energy savings device may automatically perform a second set of actions, such as alerting a consumer at a point of use to reduce load conditions, including turning off power to non-essential appliances, or automatically reducing load conditions by a second more drastic pre-set amount.

If the power signal characteristics indicate that the electric utility power grid is not recovering from the chaotic conditions, then the autonomous energy savings device may automatically shut-off all power at the point of consumption. During recovery from a grid failure condition or device shut off due to pending grid failure, each autonomous energy savings device may be programmed to include a random start interval that ensures the various points of consumption will not concurrently demand power, which may lead to grid failure.

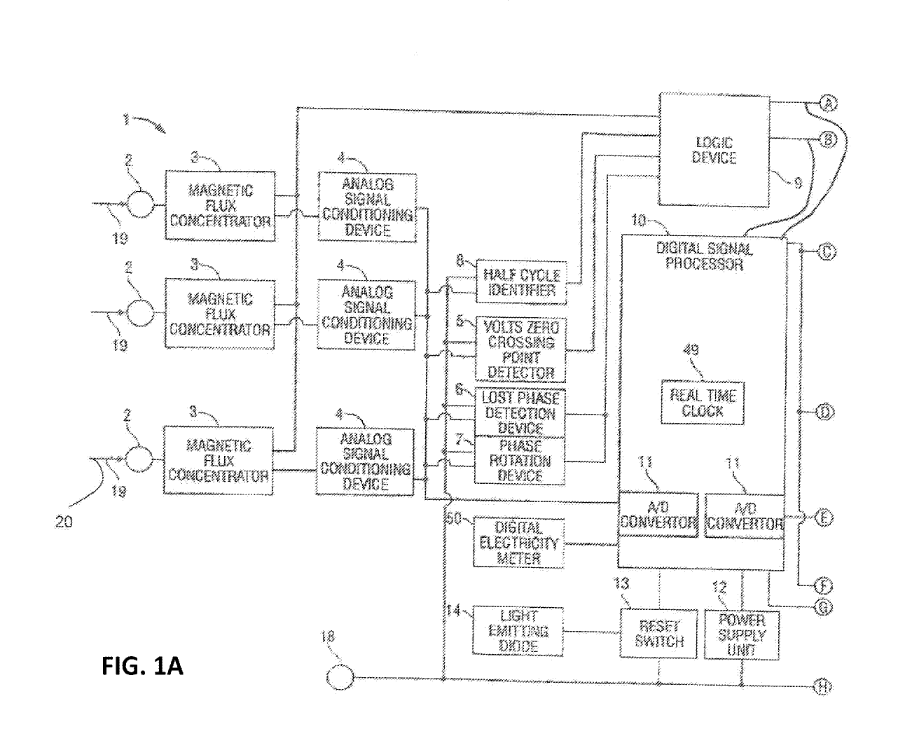

According to one example, FIGS. 1A and 1B illustrate a block diagram of an energy savings device 1 for use in a three-phase electrical system. The energy savings device 1 may include various components that are configured to reduce an amount of energy consumed from the power grid. The energy savings device 1 may be configured to reduce energy consumed, while negating or minimizing an effect of the energy reduction on performance of electronically-operated devices that are electrically coupled to the energy savings device 1.

According to one example, a predetermined amount of incoming power and energy 19 are provided to the energy savings device 1. The incoming power and energy 19 may include at least one analog signal 20 that is input into the energy savings device 1 via an input coupling 2. The input coupling may include, but is not limited to, at least one phase input connection 2. A voltage neutral 18 line may be included in the energy savings device 1. As shown in FIGS. 1A and 1B, the energy savings device 1 may be used with a three-phase electrical system (phases A, B, and C) and a voltage neutral 18 line may be provided for use as a reference point and as a sink for a clamped back-EMF that may be produced under conditions where the electrical current is interrupted while under a lagging power factor load. In some embodiments, the energy savings device 1 may be configured for use in a single phase system and/or a bi-phase system. The number of phase input connections 2 may be modified based on the number of input phases, as would be understood by one of ordinary skill in the art.

At least one phase input connection 2 is connected to at least energy sensing device 3, which is configured to sense the predetermined amount of incoming power and energy 19. The at least one energy sensing device 3 may be configured to measure voltage, current, and frequency, or the like. In some embodiments, the at least one energy sensing device 3 may include, but is not limited to, one or more of: a magnetic flux concentrator, a Hall Effect sensor, and a current transformer. The at least one energy sensing device 3 may galvanically isolate the current from the incoming power and energy 19 and report any over-current conditions to a routing device 9, which may include, but is not limited to, at least one logic device 9. The at least one logic device 9 may be configured to act as a control interface between digital signal processor (“DSP”) 10 and one or more of: volts zero crossing point detector 5 and phase rotation device 7. If an over-current condition exists, then the over-current condition may be simultaneously reported to the logic device 9 and a processor 10. The processor 10 may include, but is not limited to, a digital signal processor 10. The digital signal processor 10 may be configured to shut down the energy savings device 1 when an over-current condition report is received. This electronic protection action is designed to safeguard both the energy savings device 1 and the terminal equipment used in conjunction with the energy savings device 1 in the event of a short circuit or overload. Thus, the logic device 9 may provide protection of the power control devices in the event of a software/firmware glitch and/or power line glitch or surge in real-time as the reaction time of the logic device 9 and digital signal processor 10 may be about 5 microseconds or less.

The logic device 9 may be configured to arbitrate between the drive signals applied to the IGBT/FET half cycle control transistors 54 and 58 and the signals applied to the IGBT/FET shunt control transistors 59, 60, 67 and 68. The logic device 9 arbitration may prevent the IGBT/FET half cycle control transistors 54 and 58 and IGBT/FET shunt control transistors 59, 60, 67 and 68 from being simultaneously driven to an on-condition that could lead to the failure of the power control and/or shunt elements. Exemplary shunt control transistors 59, 60, 67, 68 may include a FET or an IGBT in parallel with a diode, as would be understood by a person of ordinary skill in the art. The digital signal processor 10 may include, but is not limited to, at least one A/D converter 11.

The incoming power and energy 19 obtained from the phase input connection 2 may be transmitted though the sensing device 3 and at least one analog signal conditioning device 4 while en route to the digital signal processor 10. After the signal(s) have been conditioned, the conditioned signals may be sent to a volts zero crossing point determining device configured to detect the point where the AC voltage goes through zero volts relative to neutral line 18, which is commonly referred to as a zero crossing point. The volts zero crossing point determining device may include, but is not limited to, at least one volts zero crossing point detector 5.

After the volts zero crossing point is detected for each phase of the analog signal 20 of the incoming power and energy 19, the analog signal 20 is transmitted to at least one phase loss detecting device, at least one phase rotation determination and rotation device, and a half cycle identification device. The at least one phase loss detecting device may include, but is not limited to, at least one lost phase detection device 6. In some embodiments, the lost phase detection may be performed on DSP 10. The at least one phase rotation determination and rotation device, may include, but is not limited to, at least one phase rotation device 7. The half cycle identification device may include, but is not limited to, at least one half cycle identifier 8. In some embodiments, the at least one half cycle identifier 8 function may be performed on DSP 10. In some embodiments the at least one phase loss detecting device, at least one phase rotation determination and rotation device, and the half cycle identification device may be configured in parallel between the analog signal 20 and the logic device 9 and digital signal processor 10.

The power control may be performed using at least one voltage reducing device, which may include, but is not limited to, at least one IGBT/FET drive control 15, in electrical connection with the digital signal processor 10 to reduce the energy by a predetermined amount. Prior to the processed signals entering the reducing device, the signals may be conditioned again through at least one analog signal conditioning device 4 so as remove any spurious signals or transient signals. The command signals that control the IGBT/FET drive control 15 of the voltage reducing device are determined by the digital signal processor 10 and mitigated by the logic device 9.

The reduced energy 24 leaving the IGBT/FET drive control 15 then passes through at least one sensing device 3 while en route to at least one outputting device. The at least one outputting device may include, but is not limited to, at least one phase output connection 17. The at least one phase output connection 17 may be configured to output electrical power to an electrically-operated device (not shown) for consumption.

The energy savings device 1 may be powered via a powering device. The powering device may include, but is not limited to, a power supply unit 12. The powering device may be configured to provide electrical power to the digital signal processor 10. An optional resetting device, which may include, but is not limited to, a reset switch 13, may be configured to permit a user to reset the device 1 as desired. In addition, an indicator device, such as an optional light emitting diode 14, may be in electrical connection with the reset switch 13 and configured to alert a user if the energy savings device 1 needs to be reset.

The energy savings device 1 may optionally include at least one digital electricity meter 50. According to one example, the digital electricity meter 50 may be a revenue accurate meter that meets or exceeds standards requirements, such as ANSI C12.20 Accuracy Class requirements. The digital electricity meter 50 may be configured to register active, reactive, and apparent energy. Furthermore, the digital electricity meter 50 may include time-of-use bins to track energy consumption at different tariff rates and may further include remote vacation options that enable automated meter reading. The digital electricity meter 50 may support industry-standard communication protocols, including TCP/IP, or the like.

The energy savings device 1 may optionally include at least one communication device, such as a USB communications interface 25, configured to interface with at least one computing device 16, the at least one computing device 16 having at least one USB port 74 and at least one window interface 40. Communication with the at least one computing device 16 may be via wired or wireless transmission. The USB communications interface 25 may permit a user to monitor, display, and/or configure the energy savings device 1 via his/her computing device 16. However, inclusion of the USB communications interface 25 is optional and may be omitted in the implementation of the energy savings device 1. In addition, a real time clock 49 may optionally be incorporated within the digital signal processor 10 or otherwise connected to the energy savings device 1.

A user may determine the operational manner in which to use the energy savings device 1, e.g., a user may select how he/she would like to save energy by one or more of: 1) inputting the desired RMS value, 2) inputting the desired percentage voltage, and 3) inputting the desired percentage savings reduction into a computing device 16. For example, if a user chooses to reduce the incoming voltage by a fixed percentage, the energy savings system 1 may permit voltage percentage reduction and may automatically lower the voltage so as to be consistent with a maximum allowed harmonic content by establishing a lower voltage threshold. The lower voltage threshold may reduce the likelihood that, in lower voltage or brown-out conditions, the energy savings device 1 does not continue to attempt to reduce the available voltage by the percentage reduction specified.

According to one example, the energy savings device 1 may include a voltage regulator without a meter, a voltage regulator and a meter, and a voltage regulator and a meter having communications capabilities. As discussed above, the digital electricity meter 50 may be a revenue accurate meter.

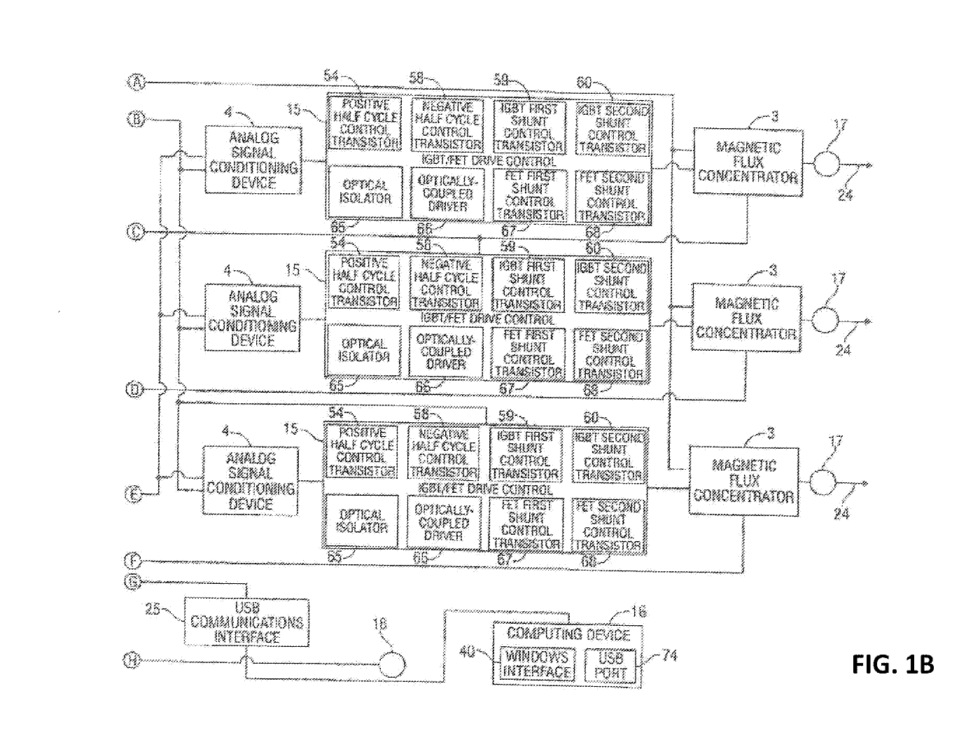

FIG. 2 illustrates a perspective plan view of a sensing device 3. The sensing device 3, shown here as one magnetic flux concentrator 3, measures AC current galvanically when connected to active circuitry of the energy savings device 1. The use of a magnetic flux concentrator as the sensing device 3 is exemplary and illustrative only, as alternative power sensing devices such as, but not limited to, a Hall Effect sensor, and a flux transformer may be used. A housing 27 may include a housing top half 29 and a housing bottom half 30 and a hinge 30 connecting the two halves 29 and 30, carries a circuit board 26 having a magnetic flux concentrator chip 37 mounted on the bottom side of the housing top half 29. The housing 27 may be substantially composed of a non-conductive material that does not interfere with magnetic fields, such as, but not limited to, a plastic enclosure. Each half 29 and 30 includes at least one notched portion wherein when the halves 29 and 30 are joined together, at least one aperture 38 is formed for permitting a conductor 28 to extend therethrough. The utilization of said housing 27 accurately defines the distance between the magnetic flux concentrator chip 37 and the core center of the conductor 28. A window detector associated with the magnetic flux concentrator chip 37 accurately determines when current, within the negative or positive half cycles, is out of a normal range. In addition, the magnetic flux concentrator 3 may include an open collector Schmidt buffer configured to allow multiple magnetic flux concentrators 3 to be connected to both the analog signal conditioning device 4 and the logic device 9.

The housing 27 may be configured to snap together and bear on a conductor 28, which may include a cable, to ensure that the conductor 28 is held firmly against the housing 27. The housing top half 29 may be dimensioned to accommodate one or more different gauge wires. A plurality of apertures 38 of various sizes (dimensioned based on the wire gauge) may be formed when the halves 29 and 30 are snapped together so as to accommodate conductors 28 of various widths. The sensing device 3 may provide galvanic isolation of the incoming power and energy 19 and perform accurate current measurement over a range of currents through multiple cable passages located within the housing 27. The magnetic flux concentrator may also have superb linearity and very low harmonic distortion as would be understood by a person of skill in the art. In addition, if the current measurement range is determined by a mechanical device, no changes are necessary to the printed circuit board 26. Sensitivity of the magnetic flux concentrator 3 may be estimated by the equation:

Vₒᵤₜ=0.06*I/(D+0.3 millimeters)

where I=current in the conductor 28 having a unit of amperes and D=the distance from the top surface of the magnetic flux concentrator chip 37 to the center of the conductor 28 having a unit of millimeters.

Since no electrical connection is made to the measurement target, full galvanic isolation may be achieved. Additionally, since there is zero insertion loss, no heat is dissipated and no energy is lost because there is no electrical connection made.

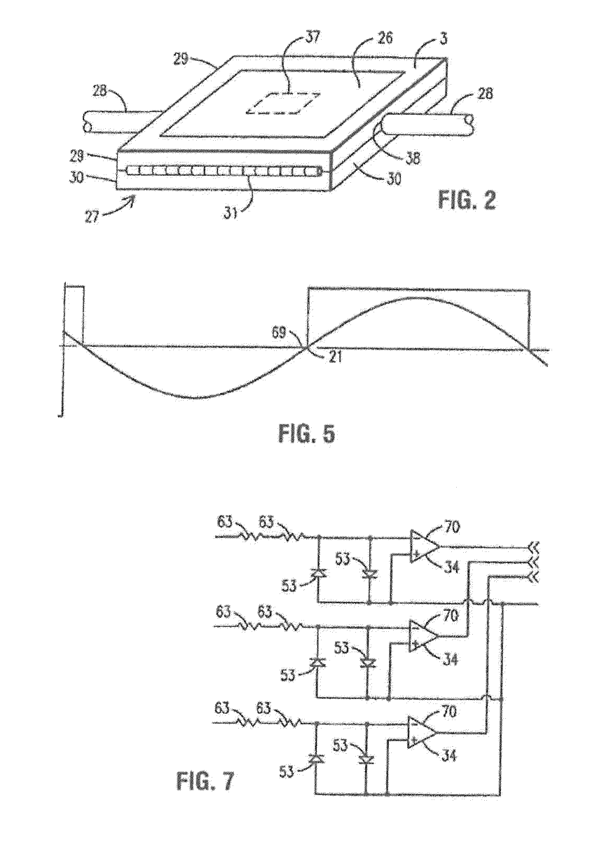

FIG. 3 is a circuit diagram of the sensing device 3. The magnetic flux concentrator 3 measures the magnetic flux generated when an alternating electric current flows through the conductor 28. Over-current is determined by comparators 34 that form a window comparator. When the thresholds set by resistors 63 are exceeded by an output of the magnetic flux concentrator 3, which may yield a “Current_Hi” signal, open collector outputs of comparators 34 go low and pass to the logic device 9 and a microprocessor non-maskable input to shut-down the energy savings device 1. To avoid ground loop problems, the magnetic flux concentrator 3 may include an integrated circuit 62 that regulates the operational voltage of the magnetic flux concentrator 3 to 5 VDC.

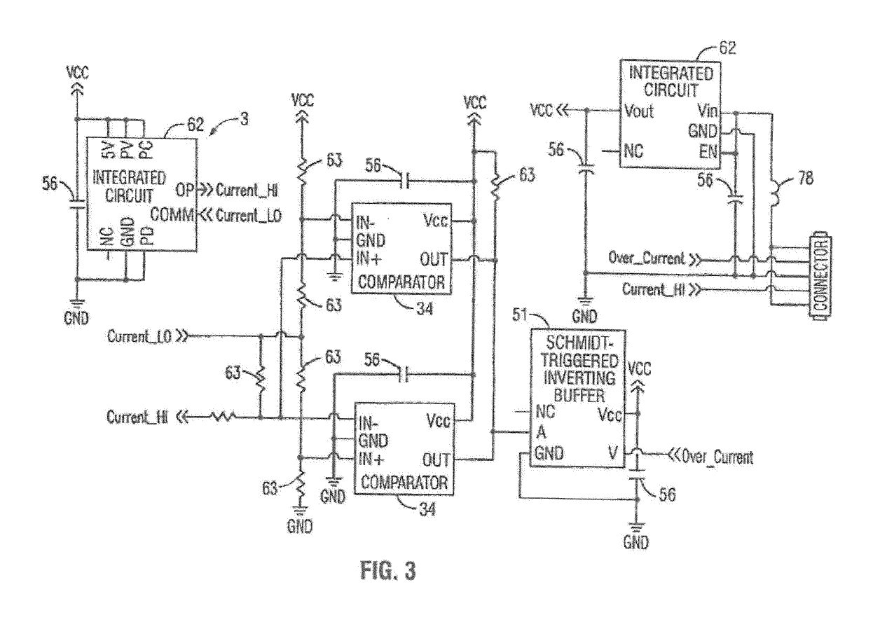

With reference to FIG. 4, a circuit diagram of a signal conditioning device is shown. The signal conditioning device, which is preferably at least one analog signal conditioning device 4, may be configured to “clean” or condition a 50/60 Hz sine wave analog signal by reducing the strength of any spurious signals or transient signals prior to its transmittal to the half cycle identifier 8. If the sine wave analog wave signal has sufficient noise or distortion, this “noise” may give rise to false volts zero cross detections, under certain circumstances.

The sine wave analog signal 20 may be conditioned using an analog signal conditioning device 4 that includes operational amplifiers 70. The operational amplifier 70 is configured as an active, second order, low pass filter to remove or reduce harmonics and any transients or interfering signals that may be present. When utilizing such filter, however, group delay may occur, wherein the group delay offsets, in time, the zero crossing of the filtered signal from the actual zero crossing point of the incoming AC sine wave. To remedy the delay, operational amplifiers 70 are provided to allow a phase change to correct the zero crossing point accurately in time as required. The output of the operational amplifiers 70 is the fully conditioned 50/60 Hz sine wave signal that is connected to the A/D converter 11 of the digital signal processor 10 (see FIGS. 1A and 1B) for root-mean-square (RMS) value measurement. This signal is approximately equal to half of the supply rail, which is necessary to enable measurement of both positive and negative half cycles. The A/D converter 11 may be configured to perform the well-known in the art 2's compliment math, or other binary math signal number representation, to set the output of the A/D converter 11 to 0xFFF at the highest (maximum peak positive) voltage and to Ox))) at the lowest (maximum peak negative) voltage. The signal also enters the half cycle identifier 8.

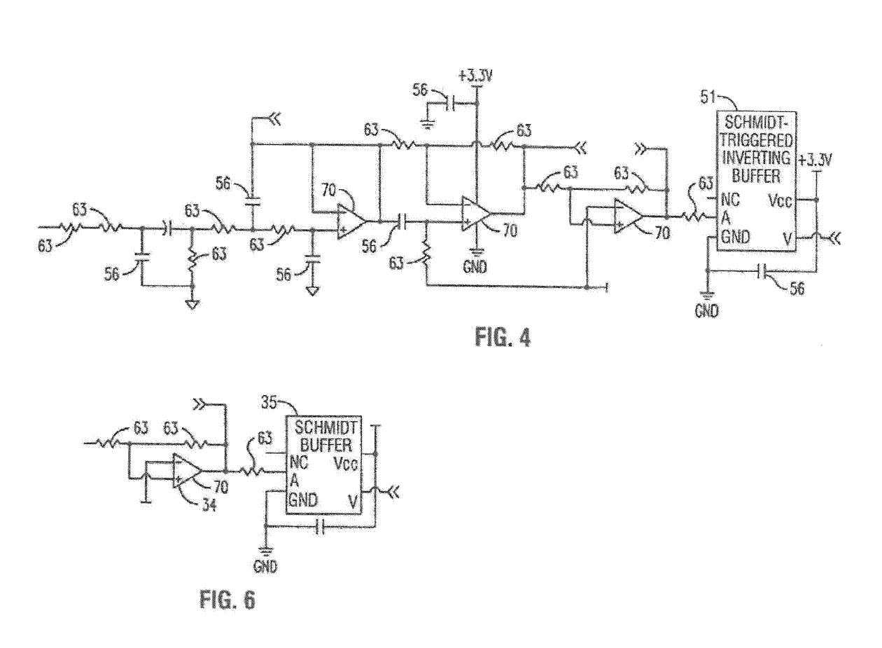

FIG. 5 shows an oscillogram of analog signal 20 as received by the volts zero crossing determining means. The analog signal 20 may include zero crossing point 21. Conditioning of the volts zero cross single may result in a square wave 69. Square wave 60 may be accurate to within a few millivolts of the actual volts zero crossing point 21 of the analog signal 20.

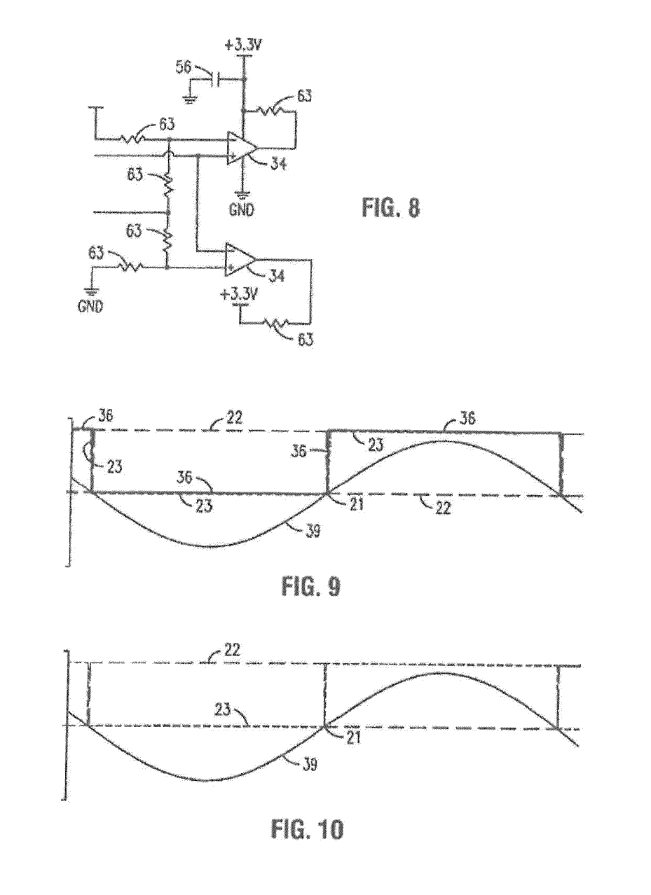

FIG. 6 shows an exemplary circuitry diagram of the volts zero crossing determining device. The volts zero crossing determining device may include at least one volts zero crossing point detector 5. An exemplary volts zero crossing point detector 5 may include an operational amplifier 70 configured as a comparator 34 with its reference set to exactly half the supply voltage using half the supply rail. The comparator 34 operates at a very high gain, and, as a result, switches within a few millivolts of the split rail voltage. The volts zero crossing determining device may include a Schmidt buffer 35. The Schmidt buffer 35 may be configured to provide additional conditioning of the zero cross signal. The square wave 69 may be produced via the Schmidt buffer 35.

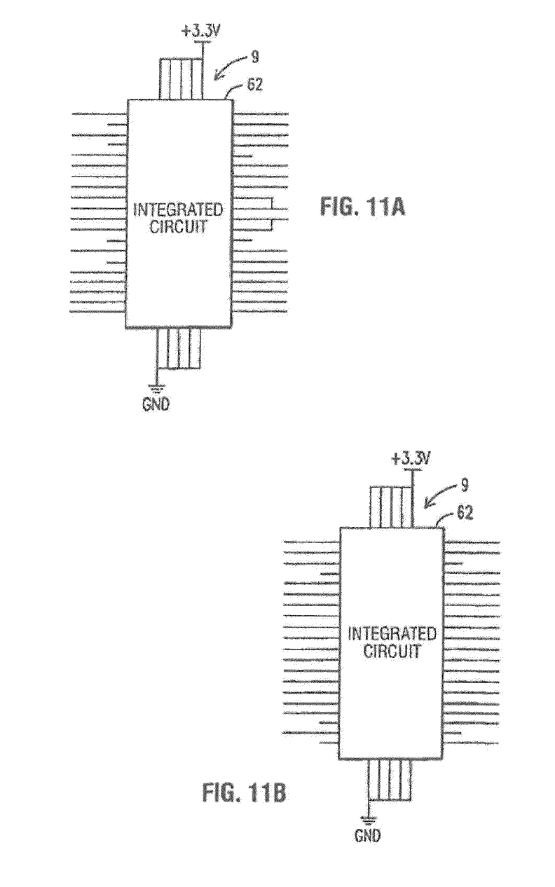

FIG. 7 shows a circuit diagram of a loss detecting device and phase rotation determination and rotating device. The loss detecting device may include at least one lost phase detection device 6, and the phase rotation determination and rotating device may include at least one phase rotation device 7. The loss detecting device and the phase rotation determination and rotating device operate together to prepare the signal for transmission to the logic device 9 and the digital signal processor 10 when utilizing a three-phase electrical system.

The lost phase detection device 6 circuitry includes operational amplifiers 70 configured as comparators 34, wherein each of the comparators 34 uses high resistance resistors in series configuration. An exemplary configuration of resistors may include two 0.5 Meg Ohm resistors in series, which may be sufficient for achieving the required working voltage of the resistors 63, and two diodes 53 connected in inverse parallel. The diodes 53 are configured to center around the volts zero crossing point 21 of the incoming sine wave 39 at approximately the voltage forward drop of the diodes 53, which is in turn applied to the comparator 34 that further conditions the signal suitable for passing to the logic device 9 and the digital signal processor 10, resulting in the system being shut down in the absence of any of the signals.

The phase rotation determination device may be configured to determine whether the phase rotation in a three-phase electrical system is A-B-C or A-C-B as would be understood by a person of ordinary skill in the art. The phase rotation may be ascertained for later use by the digital signal processor 10. The comparators 34 may be used to detect the volts zero crossing point(s) 21 and report the point(s) 21 to the digital signal processor 10. The digital signal processor 10, in turn, may control the rotational timing through timing logic. Each of the operational amplifiers 70 may act as a simple comparator 34 with the input signal, in each case, being provided by the inverse parallel pairs of diodes 53 in conjunction with the series resistors 63.

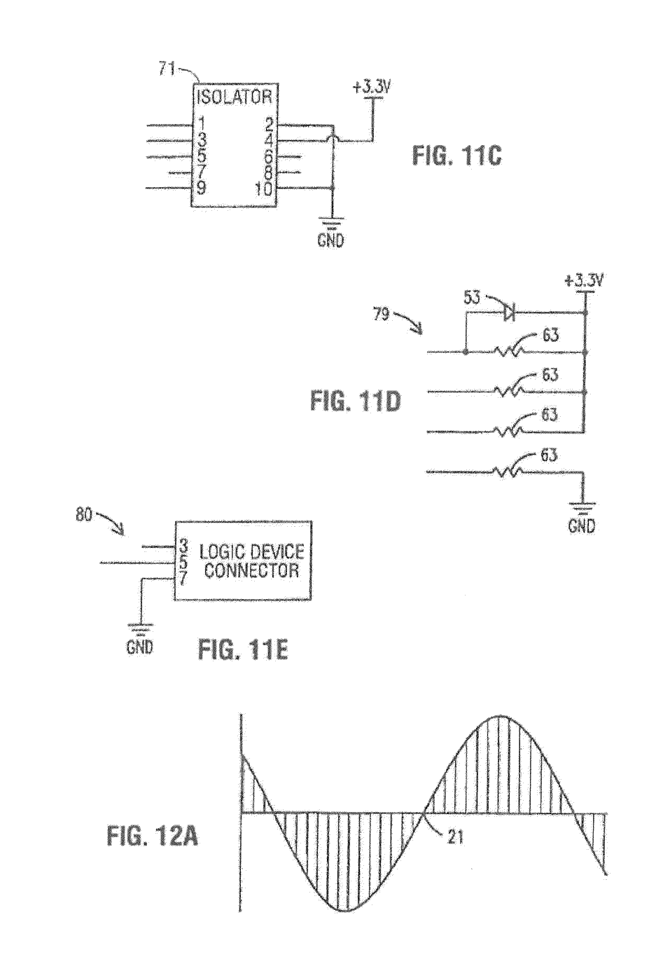

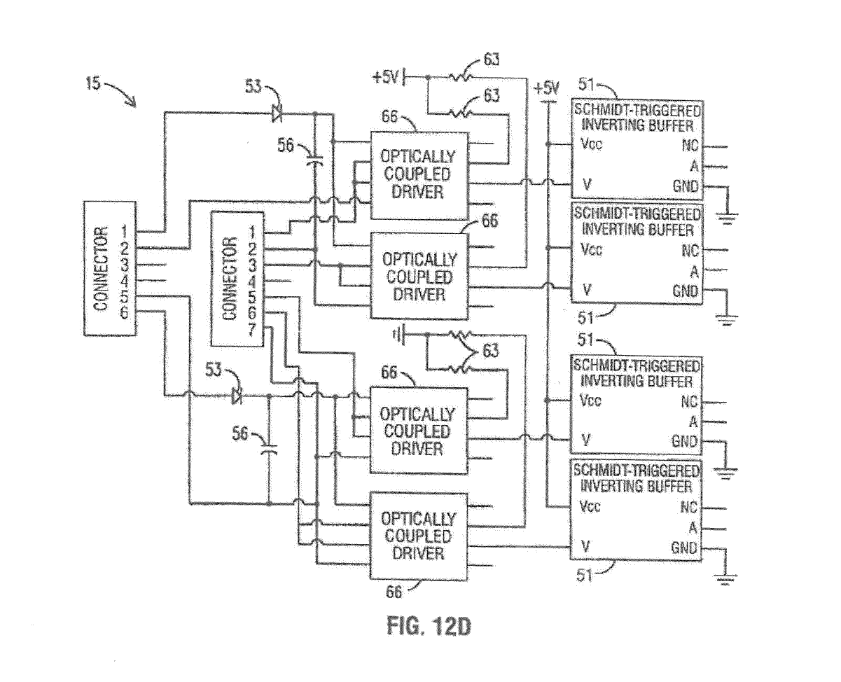

FIGS. 8, 9, and 10 show a circuit diagram and oscillograms, respectively, of a half cycle identifying device. The half cycle identifying device may include at least one half cycle identifier 8. The half cycle identifying device may provide additional data to the logic device 9 and digital signal processor 10 by identifying whether the half cycle of the analog signal is positive or negative. This additional data regarding the positive and negative half cycle may be used to avoid a situation where the IGBT/FET half cycle control transistors 54 and 58 and the IGBT/FET shunt control transistors 59, 60, 67 and 68 are simultaneously in the “on” position, which may result in a short circuit across the input power.

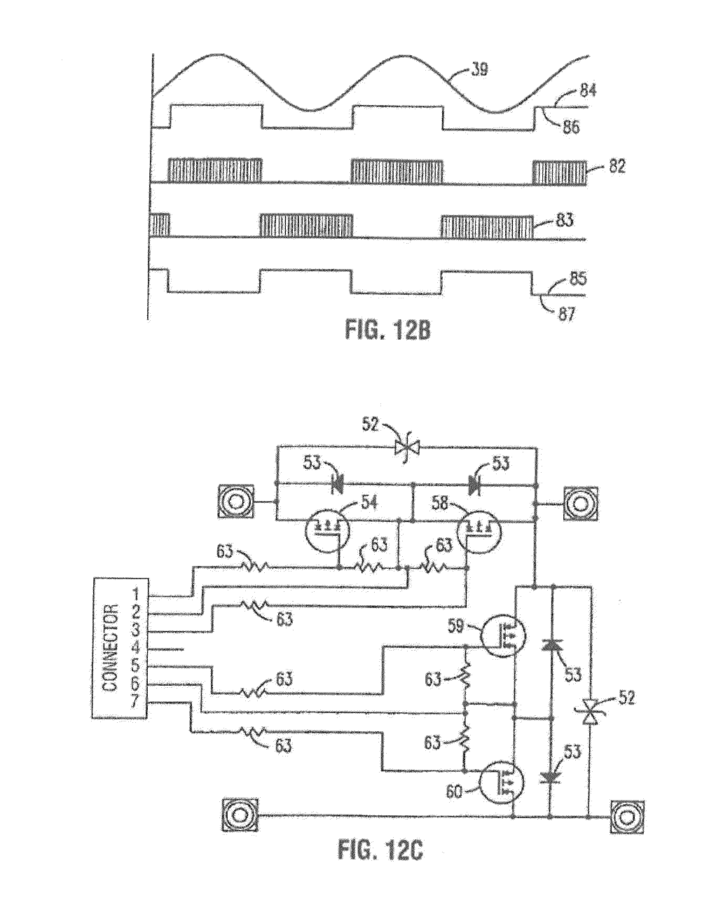

As shown in FIG. 9, there may be three signals—an absolute zero cross signal 36 and two co-incident signals. The two co-incident signals may include one co-incident signal with a positive half cycle 22 and one co-incident signal with a negative half cycle 23 of an incoming sine wave 39. The design allows the window to be adjusted to provide, when required, a “dead band.”

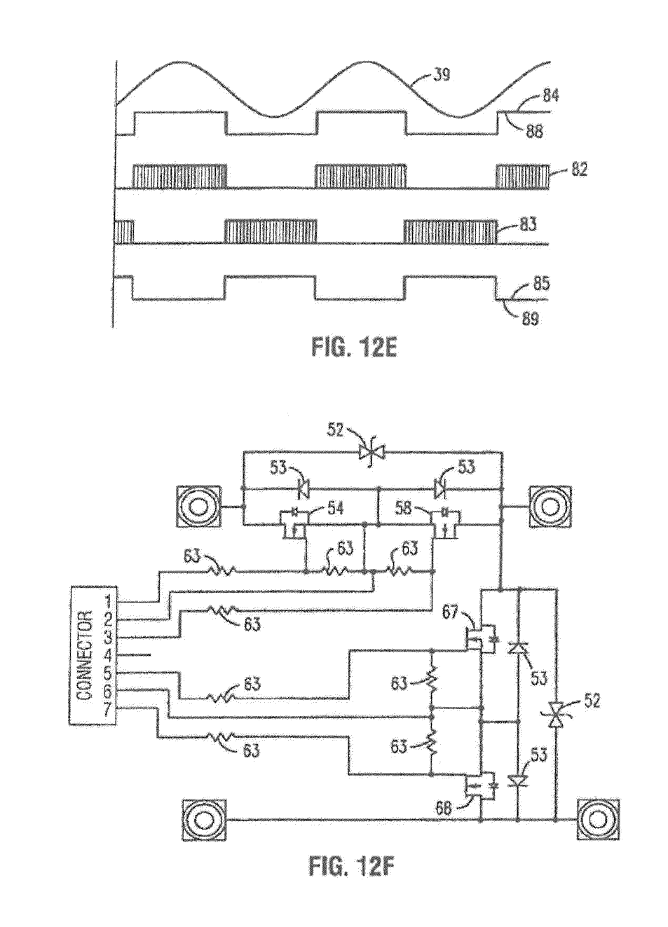

FIGS. 11A, 11B, 11C, 11D and 11E show circuit diagrams of embodiments of the routing device. The routing device may include at least one logic device 9 and may be configured to operate in real-time to arbitrate between the on-times of the IGBT/FET half cycle control transistors 54 and 58 and the IGBT/FET shunt control transistors 59, 60, 67 and 68. In some embodiments, the at least one logic device 9 may be located outside the digital signal processor 10. In some embodiments, the at least one logic device 9 may be located on the same chip or part of digital signal processor 10.

The logic device 9 may perform the routing function to assure that all signals are appropriate to the instantaneous requirement and polarity of the incoming sine wave 39 and perform the pulse width modulation function to assure the safe operation of the energy savings device 1, independent of the condition of the digital signal processor 10, presence of noise, interference, or transients. The circuitry of an isolator 71, as shown in FIG. 11C, may be used to permit programming of the logic device 9. The circuitry of the resistor support 79 of the logic device 9, as shown in FIG. 11D, may be used to operate the logic device 9. As shown in FIG. 11E, the circuitry of the logic device connector 80 enables activation and deactivation of certain aspects of the logic device 9.

Logic device 9 may be useful in modulating the power of the incoming signal, particularly since modifying a resistive load is often less demanding than modifying a reactive load, and, in particular, an inductively reactive load. The power modulation may include Pulse Width Modulation (PWM). Herein, PWM is defined as the modulation of a pulse carrier wherein at least one slice is removed from an area under the curve of a modulating wave. When PWM is applied directly to the incoming power and energy, the inductive component reacts when power is removed and attempts to keep the current going and will raise its self-generated voltage until the current finds a discharge path.

The logic device 9 may be configured to act as a “supervisor” such that the logic device 9 directs the power signal in the event that there is a malfunction in the digital signal processor 10, an over-current condition, and/or a phase loss. In any of these situations, the logic device 9 responds immediately, in real time, to safeguard the half cycle control transistors and shunt devices and the equipment connected to it.

Additionally, the logic device 9 may mitigate the complex drive requirements of the IGBT/FET half cycle control transistors 54 and 58 and the IGBT/FET shunt control transistors 59, 60, 67, and 68 and, to an extent, unloads the digital signal processor 10 of this task. Since the logic device 9 controls the drive function in this instance, the control may be performed in real time. Therefore, the timing control of the drive requirements (on the order of 10-100 nanoseconds) may be held to stricter limits than would be achieved by the digital signal processor 10. Responding in real-time may be beneficial to the safe, reliable operation of the energy savings device 1.

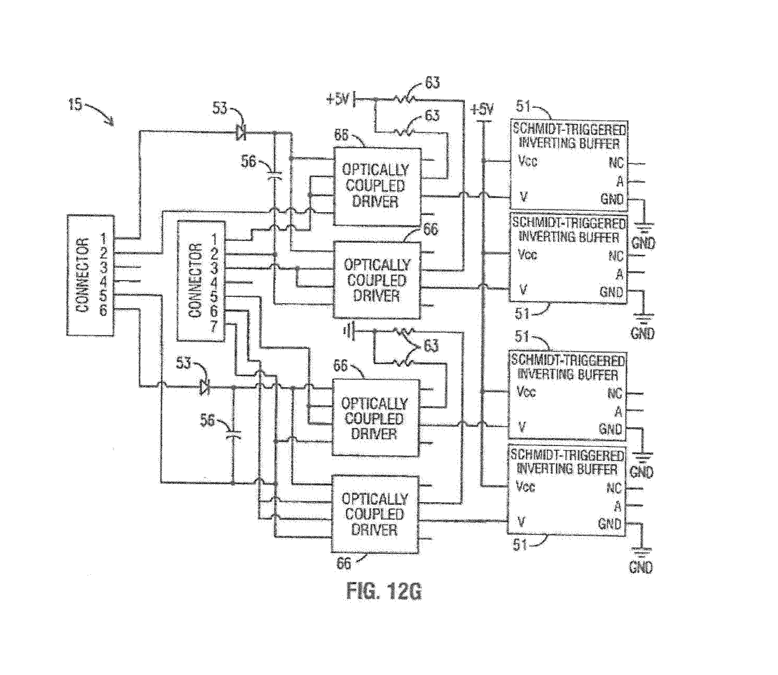

FIGS. 12A, 12B, 12C, 12D, 12E, 12F, and 12G show oscillograms and circuit diagrams of a voltage reducing device. The voltage reducing device may include at least one IGBT/FET drive control 15 configured to reduce the analog signals of the incoming sine wave 39 using PWM. Thus, the amount of energy inputted into the energy savings device 1 is reduced by having at least one slice removed from an area under the curve of the modulating sine wave 39. This energy reduction takes place without, or with significantly reduced, attendant harmonics that are commonly associated with such voltage control. This technique, as shown in FIG. 12A, works in conjunction with the inherent characteristics of the IGBT/FET devices that allows the on and off triggering point to be controlled. All of the potential energy is contained in each half cycle, the greatest amount of energy is in a complete half cycle, which has the greatest area under the curve. If each half cycle is modulated on a mark space ratio of 90%, the area under the curve is reduced by 10% and, as a result, the energy is reduced proportionally as seen in FIG. 12A.

The original shape of the input sine wave is retained and, since modulation can be performed at high frequencies (on the order of 10-100 KHz or higher), filtering of the output is possible due to the smaller size of the wound components becoming a practical proposition. The overall effect is realized when the root-mean-square value (RMS), which is the square root of the time average of the square of a quantity or, for a periodic quantity, the average is taken over one complete cycle and which is also referred to as the effective value, is correctly measured and the output voltage is seen to be reduced by a percentage similar to the mark space ratio employed. Reduced voltage results in reduced current, thereby resulting in reduced power consumed by an end user.

IGBT and FET devices are unipolar in nature so, in the case of AC control, at least one IGBT/FET drive control 15 is used to control each half cycle. Furthermore, to avoid reverse biasing, steering diodes may be used to route each half cycle to the appropriate device. Additionally, many IGBT and FET devices may have a parasitic diode shunting main element, wherein connecting two IGBT or FET devices in inverse parallel would result in having two of the parasitic diodes in inverse parallel, thereby rendering the arrangement inoperative as a controlling element.

The diodes 53 are connected across the positive half cycle transistor 54 and the negative half cycle control transistor 58 and work ideally for a purely resistive load or a current-leading reactive load. When the energy savings device 1 is driving a load with a current lagging power factor and the current in an inductively reactive component is suddenly removed, such as when the modulation occurs, a collapsing magnetic field may attempt to keep and maintain the flow of electric current may produce an Electromotive Force (EMF) that will result in an in increase in voltage until a discharge path is found to release the energy. To prevent this “back EMF” from damaging or causing a failure of one or more of the active components, additional IGBT/FET shunt control transistors 59, 60, 67, and 68 may be placed in a shunt configuration.

During the positive half cycle, the positive half cycle control transistor 54 modulates and a diode 53 is active during the complete positive half cycle. The IGBT second shunt control transistor 60 is turned fully on and a diode 53 is active. Therefore, any opposite polarity voltages resulting from the back EMF of the load are automatically clamped.

During the negative half cycle, the negative half cycle control transistor 58 modulates and a diode 53 is active during the complete negative half cycle. The IGBT first shunt control transistor 59 is turned fully on and a diode 53 is active. Again, any opposite polarity voltages resulting from the back EMF of the load are automatically clamped.

During the switching transitions, a spike may be present which may last for a very short period of time. The spike is clamped by the transorb devices 52, which are selected to absorb large amounts of energy for a very short period of time and to have a fast response time. The transorb devices 52 may also clamp any transient signals due to lightning strikes or other sources that could otherwise damage the active components of the half cycle transistors or shunt transistors. Further, while each half cycle transistor is performing pulse width modulation (“PWM”), the other half cycle transistor is turned fully on for the precise duration of the half cycle. The duties of these half cycle transistors reverse during the next half cycle. This process provides protection against the back EMF signals discussed above. This arrangement is necessary, especially near the zero crossing time when both shunt elements are in transition.

Each of the IGBT/FET half cycle control transistors 54 and 58 and the IGBT/FET shunt control transistors 59, 60, 67 and 68 have insulated gate characteristics that may require the devices to receive an enhancement voltage to enable them to turn on. This enhancement voltage may be 12 Volts in magnitude and may be supplied by a floating power supply. In some embodiments, each of the two sets of transistors may have its own floating power supply. The IGBT/FET devices are operated in the common emitter mode in the case of the IGBT's and in the common source mode in the case of the FET's, which negates the need for four isolated power supplies for each phase. Each of the pairs requires a separate drive signal that is provided by the isolated, optically-coupled drivers 66. These drivers 66 make use of the isolated supplies and serve to very rapidly turn-on and turn-off each power device. These drivers 66 are active in both directions, which is necessary since the input capacitance of the power devices are high and have to be actively discharged rapidly at the turn-off point and charged rapidly at the turn-on point.

When driving an inductively reactive load, direct PWM may result in back EMF when the IGBT modulates off, and that back EMF may need to be clamped. Referring to FIG. 12B, an incoming sine wave 39 that is applied to the positive half cycle control transistor 54 and the negative half cycle control transistor 58 is shown. Normally, these half cycle control transistors 54 and 58 are in the “off” condition and need to be driven “on” During the positive half cycle, the positive half cycle control transistor 54 is modulated and works in conjunction with a diode 53 to pass the modulated positive half cycle to a line output terminal. The IGBT second shunt control transistor 60 is on for the duration of the half cycle and operates in conjunction with a diode 53 so as to clamp the back EMF to ground.

During the positive half cycle, the negative half cycle control transistor 58 is turned on fully and its “on” condition is supported by a diode 53. These diodes 53 perform the appropriate steering of the signals. During the modulation of the positive half cycle, the negative half cycle control transistor 58 is turned on and the negative back EMF is passed through a diode 53 to be clamped at the simultaneous AC positive half cycle voltage. Although no modulation is applied to the IGBT first shunt control transistor 59 and the IGBT second shunt control transistor 60, these transistors 59 and 60 work in conjunction with diodes 53 in a similar manner as set forth above.

As shown in FIG. 12B, during the positive half cycle 22, a drive signal 85 is applied to the negative half cycle control transistor 58 and a drive signal 87 is applied to the IGBT second shunt control transistor 60. During the negative half cycle 23, a drive signal 84 is applied to the positive half cycle control transistor 54 and a drive signal 86 is applied to the IGBT first shunt control transistor 59. The positive half cycle drive signal 82 applied to the positive half cycle control transistor 54 and the negative half cycle drive signal 83 applied to the negative half cycle control transistor 58 are also shown.

Similarly, as shown in FIG. 12E, which is an oscillogram of the voltage reducing device of the FET-based present disclosure, during the positive half cycle 22, a drive signal is applied to the negative half cycle control transistor 85 and a drive signal is applied to the FET second shunt control transistor 89. During the negative half cycle 23, a drive signal is applied to the positive half cycle control transistor 84 and a drive signal is applied to the FET first shunt control transistor 88. The positive half cycle drive signal 82 applied to the positive half cycle control transistor 54 and the negative half cycle drive signal 83 applied to the negative half cycle control transistor 58 are also shown.

In summary, there are two clamping stratagems used, the first for the positive half cycle and the second for the negative half cycle. During the positive half cycle, when the positive half cycle control transistor 54 is modulated, the negative half cycle control transistor 58 and the second shunt control transistor 60 are on. During the negative half cycle, when the negative half cycle control transistor 58 is modulated, the positive half cycle control transistor 54 and the IGBT first shunt control transistor 59 are on.

The hardware utilized in the IGBT-based and FET-based versions of energy savings device 1 are substantially identical with the only difference being the IGBT/FET half cycle control transistors 54 and 58 and the IGBT/FET shunt control transistors 59, 60, 67 and 68. The exemplary circuit diagram of the IGBT-based circuitry is shown in FIG. 12C; the exemplary circuit diagram of the IGBT-based driver is shown in FIG. 12D; the exemplary circuit diagram of the FET-based circuitry is shown in FIG. 12E; and the exemplary circuit diagram of the FET-based driver FIG. 12F is shown.

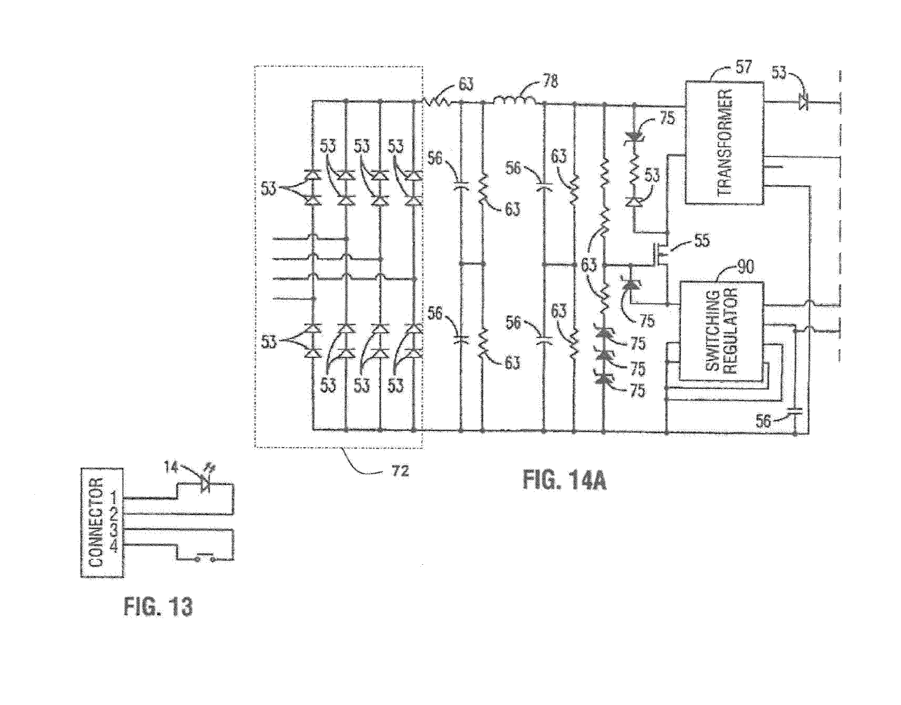

With reference to FIG. 13, a circuit diagram of a combined resetting device and indicator device is shown. The resetting device may include at least one reset switch 13, and the indicator device may include at least one light emitting diode 14. The reset device and the indicator device may work together to indicate when the IGBT/FET-based energy savings device 1 is not operating properly and to permit a user to reset the device 1. The light emitting diode 14 may indicate that the energy savings device 1 is working properly by flashing on/off. If a fault condition occurs, the light emitting diode 14 may change from its normal operation pattern to indicate the fault condition. The fault condition indication may include an uneven pattern that is distinct from the normal operation pattern.

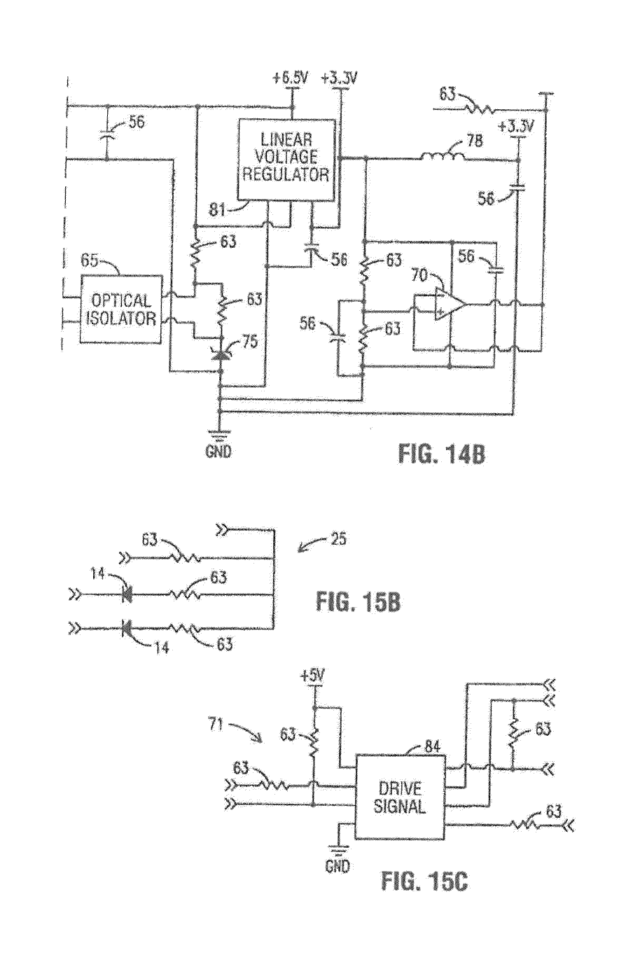

FIGS. 14A and 14B show a circuit diagram of a powering device. The powering device may include a power supply unit 12 configured to accept a variety of inputs, including, but not limited to, single phase 80 Vrms to 265 Vrms, bi-phase 80 Vrms to 600 Vrms, three-phase 80 Vrms to 600 Vrms, and 48 Hz to 62 Hz operation.

The power supply unit 12 may be fully-isolated and double-regulated in design. On the input side, a rectifier 72 including a plurality of diodes 53 may accept single, bi- and three-phase power. The power may be applied to a switching regulator 90 and integrated circuit 62 via a transformer 57. Transistor 55 may be used to control current to the transformer 57 as a flyback switching MOSFET (or IGBT). The secondary of transformer 57 may have a diode 53 and a reservoir capacitor 56. The DC voltage across capacitor 56 may be passed, via the network resistors 63 and a Zener diode 75, to an optical isolator 65 and finally to the feedback terminals. Use of the optical isolator 65 provides galvanic isolation between the input and the supply output (6.4V DC). Finally, the output of the linear voltage regulators 81 (3.3 VA DC) may be passed to an operational amplifier 70, which is configured as a unity gain buffer with two resistors 63 that set the split rail voltage. The main neutral may be connected to this split rail point and also a zero Ohm resistor. An inductor 78 may isolate the supply rail digital (+3.3V) from the analog (3.3 VA) and reduce noise.

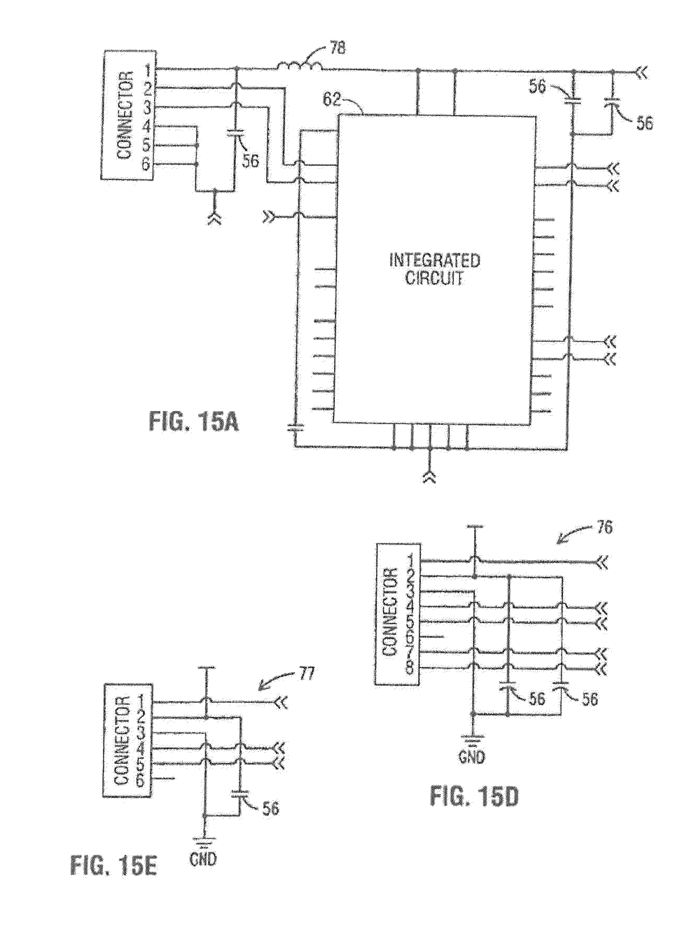

FIGS. 15A, 15B, 15C, 15D and 15E show the circuitry of a communication device. The communication device may include at least one USB communications interface 25 and may be configured to enable a user to monitor and set the parameters of the energy savings device 1 as desired. The circuitry of the USB communications interface 25 is shown in FIG. 15B; an isolator block 71 used in isolating the USB communications interface 25 from the digital signal processor 10 is shown in FIG. 15C; and first and second connectors 76 and 77 for connecting the communications means to the digital signal processor 10 are shown in FIGS. 15D and 15E.

Since the main printed circuit board is not isolated from neutral, the USB communications interface 25 may be galvanically isolated using a built-in serial communications feature of the digital signal processor 10 to serially communicate with the communication device. Signals, on the user side of the isolation barrier, may be applied to an integrated circuit 62, which is a device that takes serial data and translates it to USB data for direct connection to a computing device 16 via a host USB port 74. The host USB 5V power may be used to power the communication device 46 and may remove a need of providing isolated power from the unit. Operation of the TX (transmit) and RX (receive) channels may be indicated by two activity light emitting diodes 14. Communications may operate at a suitable data rate/bandwidth as would be understood by one of skill in the art. On exemplary data rate is 9600 Baud. Although the inclusion of a communications device is optional with regard to the performance of the energy savings device 1, this feature may facilitate use of the energy savings device 1.

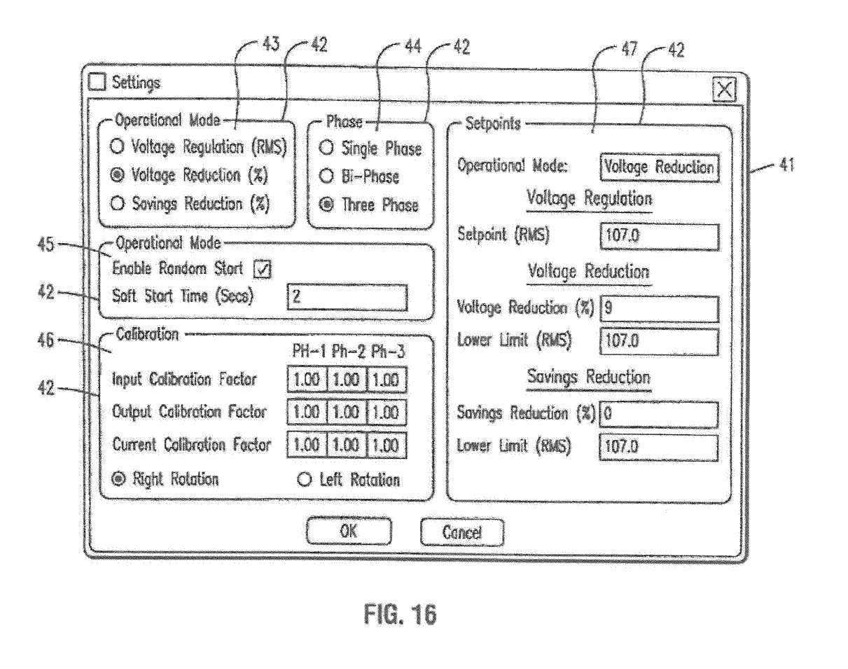

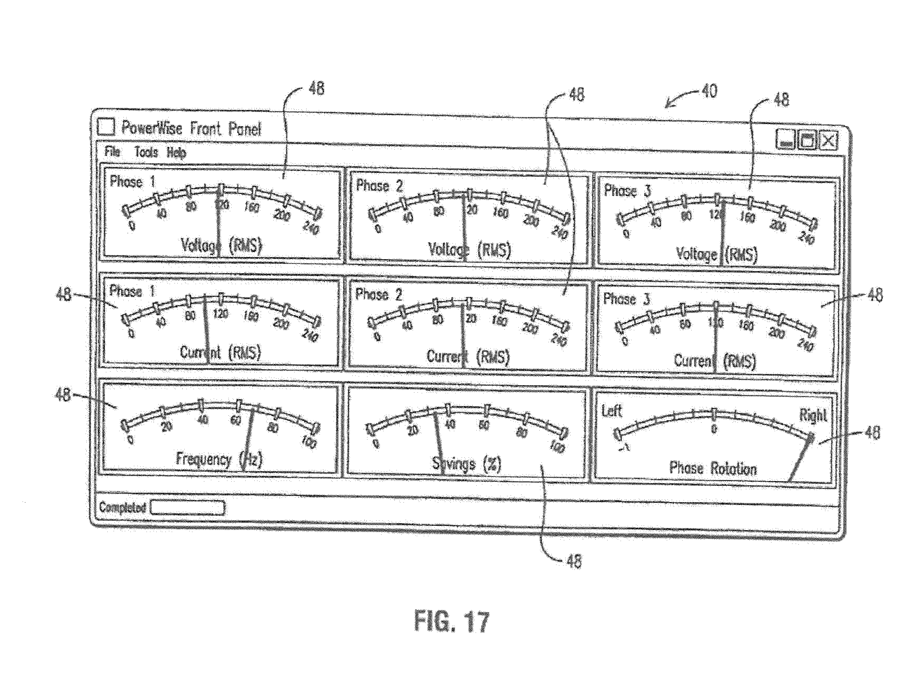

FIGS. 16 and 17 show exemplary screen shots of a windows interface 40. The windows interface 40 may be displayed on the computing device 16 and may permit a user to monitor and configure the energy savings device 1 as desired. A main control screen 41 having a plurality of fields 42 may be used by a user to monitor and adjust the energy savings device 1. For example, an exemplary plurality of fields 42 may include an operational mode field 43, a phase field 44, a startup field 45, a calibration field 46 and a set points field 47.

In the operational field 43, a user may select the manner in which the user desires to conserve energy. For example, energy conservation may include, but is not limited to, one or more of: 1) voltage reduction percentage wherein the output Volts is adjusted by a fixed percentage, 2) savings reduction percentage wherein the output Volts is aimed at achieving a savings percentage, and 3) voltage regulation wherein the root mean squared Volts output is a pre-set value. The phase field 44 permits a user to select the phase type used in connection with the energy savings device 1, i.e., single phase, bi-phase or three phase. The startup field 45 permits a user to configure the system and energy savings device 1 to randomly start and/or to have a delayed or “soft start” wherein the user inputs the delay time in seconds in which the device 1 will start. The calibration field 46 permits a user to input the precise calibrations desired and/or to rotate the phases. The setpoints field 47 displays the settings selected by the user and shows the amount of energy saved by utilizing the energy savings device 1, including voltage regulation, voltage reduction percentage, or power savings reduction percentage. With respect to percentage voltage reduction, the lower limit RMS is set below the incoming voltage that is passed through to permit the incoming voltage to be passed through when it is less than or equal to the lower limit voltage. With respect to the percentage savings reduction, the lower limit RMS is set below the incoming voltage that is passed through.

Indicators 48 may be included on the windows interface 40 to display one or more of operating current, operating voltage, line frequency, calculated power savings and phase rotation. A real time clock 49 may be incorporated into the windows interface 40 to allow programming of additional voltage reduction for a predetermined time and a predetermined operational time, e.g., for seasons, days of the week, hours of the day, for a predetermined operational time. In addition, a user may program the energy savings device 1 to operate during various times of the day. The real time clock 49 is set through a communications port or fixed to allow the selection of defined seasonal dates and time when, through experience, are known to exhibit power grid overload. During these times, the system allows further reduction of the regulated AC voltage, thereby reducing the load on the grid. Multiple times may be defined, and each of the times may have its own additional percentage reduction or voltage drop.

The digital electricity meter 50 provides a device to log statistical data on power usage, power factor, and surges, or the like. The digital electricity meter 50 may also provide the ability to include capacitors for power factor correction, and may operate on single, bi and three-phase systems. Furthermore, the digital electricity meter 50 may be configured to operate on all world-wide voltages. It may be used remotely or locally to disable or enable the user's power supply at will by the provider. In addition, the digital electricity meter 50 may detect when the energy savings device 1 and system has been bridged by an end user attempting to avoid paying for energy consumption wherein the provider is alerted to such abuse. Finally, use of the real time clock 49 permits a user and/or provider to reduce the consumption of power at selected times of a day or for a selected time period, thereby relieving and/or eliminating brown-out conditions.

Referring to FIGS. 18-21, systems and methods are provided for autonomously determining the stability of a power grid network. According to one example, the energy savings device 1 may be configured to statistically analyze characteristics of the power grid and to progressively adjust power demands so that the analyzed characteristics fall within pre-defined grid stability operating conditions. The method may be implemented with the energy savings device 1 discussed herein or other suitable energy savings device. According to one example, an electric power utility may communicate with energy savings devices 1 to adjust power demand. For example, electric power utility may communicate with energy savings devices 1 during non-normal operation conditions such as grid instability conditions to reduce power demand, thereby maintaining reliable delivery of electricity to electric power utility customers.

According to one example, the energy savings devices 1 may employ computer-implemented algorithms that assign pre-defined values for power signal characteristics. The pre-defined values may be provided by the electric utility to regulate power demand corresponding to an AC line. For example, the power signal characteristics may include a voltage. When the line voltage is determined to be too high, the energy savings device 1 may be programmed to reduce the line voltage to a pre-defined value set by the electric utility. By contrast, when the line voltage is determined to be too low, the energy savings device 1 may be programmed to boost the line voltage to the pre-defined value. Regulating voltage by reducing and boosting the line voltage may reduce or eliminate appliance power shedding such that appliances may be made to operate at an optimal power level. Additionally, by locally regulating voltage at the point of consumption, the energy savings device 1 may reduce power demand on the electric utility grid, which in turn may increase stability of the electric utility power grid. Accordingly, enhancing stability of the electric utility power grid may be achieved without needing to introduce additional hardware for specific control of individual electricity consuming devices at the point of consumption.

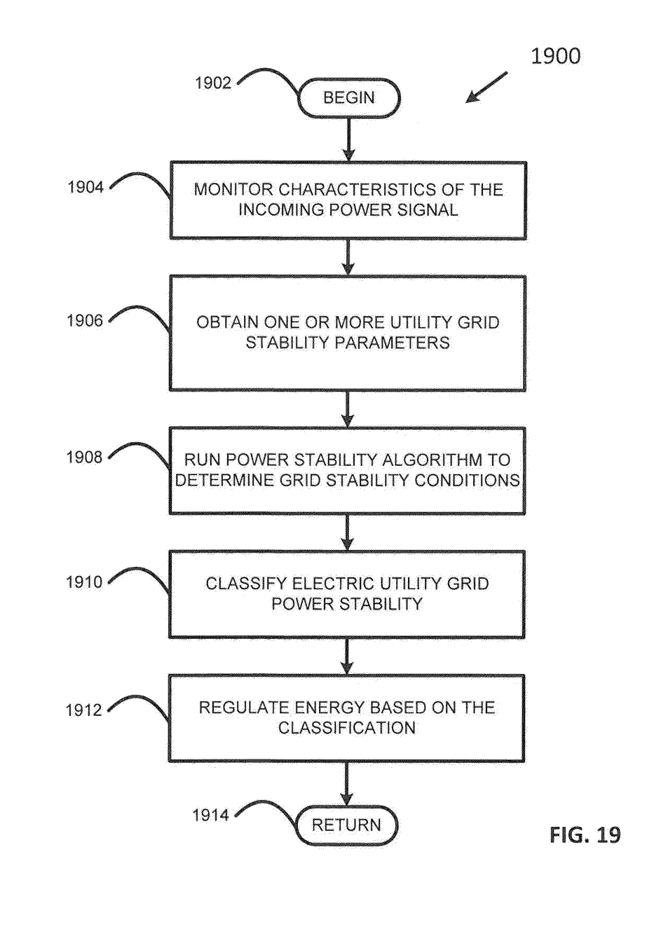

FIG. 18 illustrates a diagram of an electric power grid stability system 1800 according to one example. The electric power grid stability system 1800 may include an energy savings system, such as the energy savings device 1, a non-transitory computer-readable medium 1810, and at least one processor 1820 configured to execute instructions stored on the non-transitory computer-readable medium 1810. When executed on the processor 1820, the instructions may perform a method 1900 illustrated in FIG. 19 for increasing stability of an electric utility power grid 1830. The processor 1820 may be configured to receive information pertaining to at least one stability parameter or power signal characteristic. The processor 1820 may be configured to communicate with components of the energy savings device 1. The energy savings device 1 may be configured to receive power from the electric utility power grid 1830 and to transmit power to a consumer power load 1840. The consumer power load 1840 may include a local power distribution point, such as an input to a residence or a factory. The non-transitory computer-readable medium 1810 may include, but is not limited to, one or more of: i) a flash drive, ii) an EEPROM, iii) a hard disk, and iv) a solid state memory device, or the like.

FIG. 19 shows an example method 1900 of enhancing stability of the electric utility power grid 1830. The method begins at step 1902 and continues to step 1904. At step 1904, the method monitors one or more characteristics of the incoming energy or power signal. The power signal characteristics may include, but are not limited to, voltage, frequency, rotor angle, and current. The method may store the power signal characteristics and may maintain a record of the power signal characteristics over a period of time.

At step 1906, the energy savings device 1 obtains one or more utility grid stability parameters. The utility grid stability parameters may include small angle rotor stability parameters, transient rotor angle stability parameters, short term rotor angle stability parameters, short term frequency stability parameters, long term frequency stability parameters, short term voltage stability parameters, and long term voltage stability parameters, among other utility grid stability parameters.

At step 1908, the energy savings device 1 runs a power stability algorithm to determine power grid conditions relating to stability. According to one example, the stability or instability of a power grid may be determined by monitoring power signal characteristics and comparing obtained power signal characteristics with utility grid stability parameters associated with pre-determined conditions. Accordingly, instability of a power grid may be detected before signs of instability, such as brownout conditions, are observed by the end customer. One contributor to instability is an imbalance between the supply of power and the demand for power. During real-world conditions, end customer demand for power fluctuates according to several factors such as weather, time of day, seasons, and large-scale events, among other factors.

Once power is produced by electric utilities, the power must be used, otherwise it is wasted. In other words, electric utilities have limited ability to store produced power or energy. Electric utilities invest vast resources to produce power, so it is challenging to vary the supply of power within short periods of time. Accordingly, a desired solution for stabilizing a power grid is to control demand for power at the point of consumption. By varying power demand across thousands, tens of thousands, or more end customers the accumulated variations in power demand may add up to significant demand variations.

With respect to power signal characteristics, the energy savings device 1 may monitor frequency values to determine stability conditions of the power grid 1830. For example, when large power demands are placed on the power grid in a short period of time, frequency values may drift downward. Alternatively, when the supply of power and demand for power are not matched, frequency values may drift upward or downward from a desired value. Accordingly, the energy savings device 1 may predict stability or instability of the power grid by monitoring frequency values.

Additionally, the energy savings device 1 may monitor line voltage values to determine stability conditions of the power grid 1830. For example, when large power demands are placed on the power grid in a short period of time, voltage values may drift downward. Alternatively, when the supply of power and demand for power are not matched, voltage values may drift upward or downward from a desired value. Accordingly, the energy savings device 1 may predict stability or instability of the power grid by monitoring line voltage values.

Still further, the energy savings device 1 may monitor rotor angle values to determine stability conditions of the power grid 1830. For example, when large power demands are placed on the power grid in a short period of time, rotor angle values may increase. Alternatively, when the supply of power and demand for power are not matched, rotor angle values may vary from a desired value. Accordingly, the energy savings device 1 may predict stability or instability of the power grid by monitoring rotor angle values. One of ordinary skill in the art will readily appreciate that other power signal characteristics may be monitored to determine stability conditions of the power grid 1830.

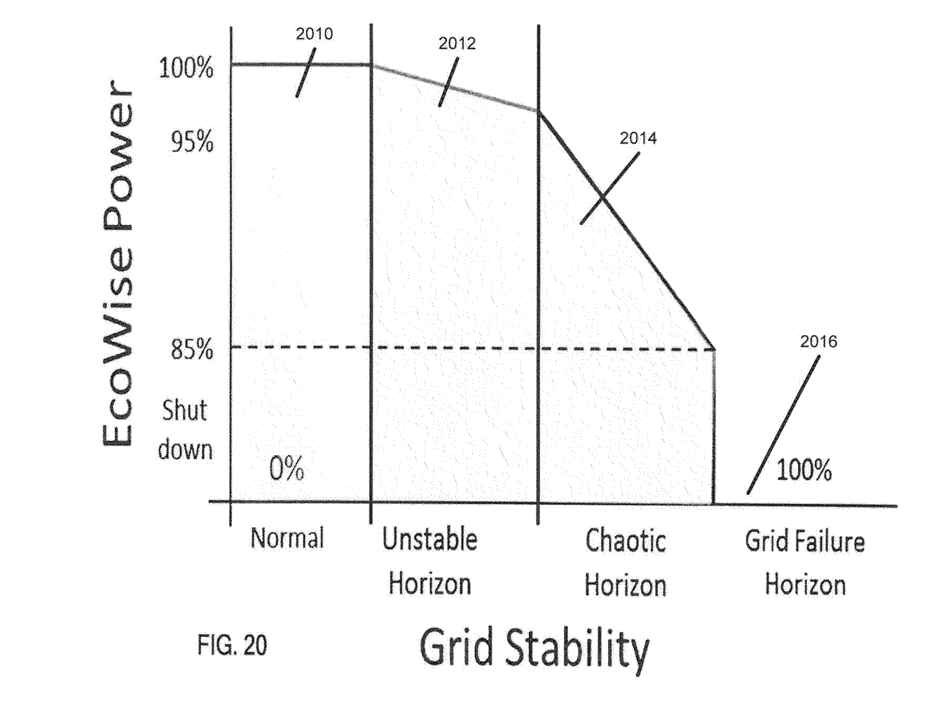

As illustrated in FIG. 20, the power grid stability conditions may be divided into various categories including a normal condition 2010 category, an unstable horizon condition 2012 category, a chaotic horizon condition 2014 category, and a grid failure horizon condition 2016 category. The unstable horizon condition 2012 category and the chaotic horizon condition 2014 category correspond to fault categories. One of ordinary skill in the art will readily appreciate that a greater number or a lesser number of categories may be provided.

According to one example, the normal condition 2010 category may be identified when the power level is substantially at 100%. For example, under the normal condition 2010 category in a U.S. region, the line voltage may be substantially 115V. The unstable horizon condition 2012 category may be identified when the power level is substantially between 95-99%. For example, under the unstable horizon condition 2012 category in a U.S. region, the line voltage may be in the range of 105-113V or 117-125V. The chaotic horizon condition 2014 category may be identified when the power level is substantially between 85-95%. For example, under the chaotic horizon condition 2014 category in a U.S. region, the line voltage may be in the range of 95-104V or 126-133V. The grid failure horizon condition 2016 category may be identified when the power level is below 85%, for example. During the grid failure horizon condition 2016, power to the energy savings device 1 may be shut off. One of ordinary skill in the art will readily appreciate that the power ranges may be adjusted as desired for the various categories.

By dividing the grid stability analysis into various categories, the energy savings device 1 may respond to the monitored conditions in a more appropriate manner. For example, when the energy savings device 1 identifies that the power grid is operating in the normal condition 2010 category, the energy savings device 1 may respond by operating according to boost/buck energy savings protocols. When the energy savings device 1 identifies that the power grid is operating in the unstable horizon condition 2012 category, the energy savings device 1 may respond by operating to buck or lower the voltage value at the point of consumption by a small amount that will not affect operation of appliances and therefore may not be noticed by end customers. For example, the voltage value may be reduced within a range of 5-10%. Other actions may be taken at the point of consumption to ease the power demand on the power grid.

When the energy savings device 1 identifies that the power grid is operating in the chaotic horizon condition 2014 category, the energy savings device 1 may respond by operating to more drastically buck or lower the voltage value at the point of consumption. Under this protocol, appliance operation will be affected and therefore end customers may notice power demand changes implemented by the energy savings device 1. For example, the voltage value may be reduced within a range of 11-20%. Alternatively, the energy savings device 1 may alert the end customer to shed power by generating an audible signal, by flickering lights, or by alerting the end customer in other ways. Other actions may be taken at the point of consumption to shed power demand on the power grid.

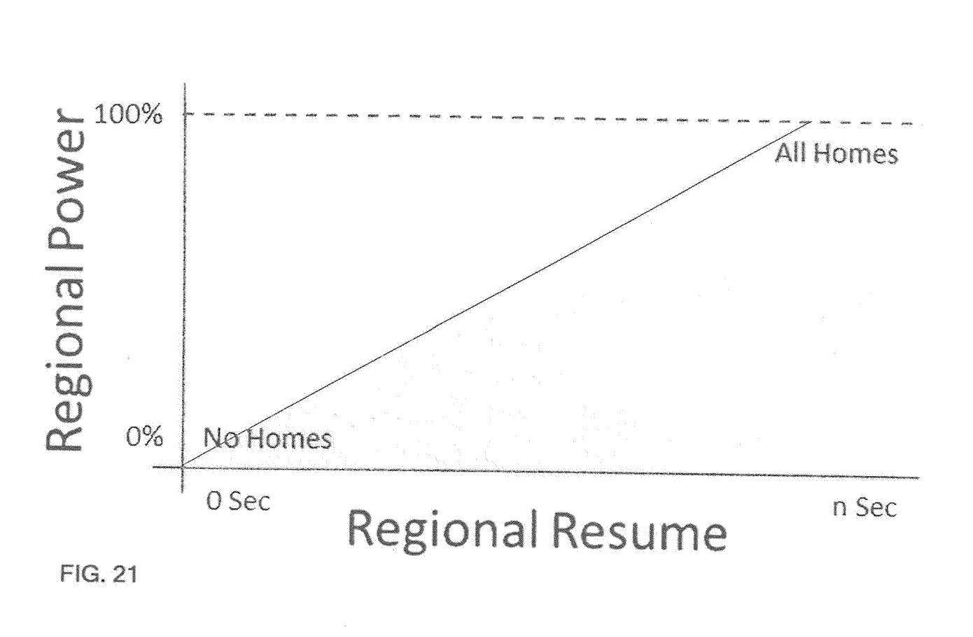

When the energy savings device 1 identifies that the power grid is not recovering from a fault category, the energy savings device 1 may respond by operating in the grid failure horizon condition 2016 category to shut off power at the point of consumption. Under this protocol, appliance operation will cease and the energy savings device 1 may continue monitoring power or energy signal characteristics. Under this protocol, the end customer may need to manually restart the energy savings device 1. Alternatively, the energy savings device 1 may automatically restart upon determining from the monitored power or energy signal characteristics that the power grid is sufficiently stable to supply power or energy. The energy savings device 1 may restart under a random restart condition as discussed below with reference to FIG. 21. Other actions may be taken at the point of consumption.

Returning to FIG. 19, the power stability algorithm 1908 may use any number of the monitored characteristics from step 1904 and the utility grid stability parameters from 1906 to determine the electric utility grid power stability and grid stability conditions.

According to one example, the power stability algorithm may utilize power signal characteristics such as the rotor angle, the grid frequency, and the distribution voltage to determine the grid stability conditions. Over time, the power signal characteristics may be used to determine a stability of the power grid by creating an instantaneous probability distribution of the potential for a grid failure. According to one example, the power stability algorithm may employ three probability distribution equations corresponding to each different type of power signal characteristics. The three probability distribution equations may be represented as:

Rot Angle Stability [symbol] Pᵣ{t,θₐ,θₜ,θₛ} (2)
t=time
θₐ=Small Angle Rotor Stability
θₜ=Transient Rotor Angle Stability
θₛ=Short Term Rotor Angle Stability

Grid Frequency Stability [symbol] P_{f}{t,ω_{S},ω_{L}} (3)
t=time
ω_{S}=Short Term Frequency Stability
ω_{L}=Long Term Frequency Stability

Grid Voltage Stability [symbol] Pᵥ{t,V_{S},V_{L}} (4)
t=time
V_{S}=Short Term Voltage Stability
V_{L}=Long Term Voltage Stability.

According to one example, the rotor angle stability is defined as a phase angle difference between the grid phase angle and the generator rotor angle. Rapid power or energy demands placed on the grid during a fault in the grid network contribute to an out of phase rotor angle. Rotor angle stability may be detected on the power grid as small but quick changes in the grid frequency. The stability may be classified as an over-damped response, an under-damped response, or critically damped response. An under-damped response may be serious and may cause a network to fail. An over-damped response is a preferred stability mode as long as it does not over-torque the generator rotor. A critically damped response may eventually lead to grid instability. Improved stability may be obtained through small rotor angle deviation, fewer transients over time, and reduced overall length of time that a rotor dynamically perturbates from zero phase displacement. In some examples, the rotor angle stability variables may be estimated using a harmonic of the incoming energy or power signal.

According to another example, the frequency stability is a number of degrees a grid deviates from a desired frequency such as 60 or 50 Hz. Statistical deviations in grid frequency may be directly proportional to grid instability. Grid frequency stability is measured in terms of short duration and long duration, with short duration deviation being more unstable than long term deviation. Grid frequency perturbation is generally caused by a grid operator's inability to meet the networks power demand.

According to yet another example, voltage stability is a variation of voltage from a desired value. Generally, voltage reduction is more unstable than a voltage boost. Variations in voltage over time are an indication of the stability of the distribution system, with short term variations often being more serious than long term variations.

An overall grid probability of failure may be estimated by combining the individual probabilities of failure, such as by summing equations (2), (3), and (4) as shown below:

P_{fail}=Pₐ+P_{f}+Pᵥ (5)

where P_{fail} is a total probability that the electric utility grid will failure. In some examples, constants may be used for one or two of the component probabilities (Pₐ, P_{f}, Pᵥ). In other examples, the P_{fail} may include weighted component failure probabilities.

P_{fail} can be greater than 1 and may be computed differently for each electric utility grid. The individual equations (2), (3), and (4) may be determined through statistical and/or empirical analysis of the electric utility grid. Once P_{fail} is determined, a weighting function may be applied to determine how much the overall power should be reduced.

When determining the electric utility power grid stability and grid stability conditions, the power stability algorithm 1908 may use software algorithm to perform: i) statistical averaging, ii) statistical time state averaging, iii) a stochastic differential methodology, iv) curve fitting, v) a pattern table look up of the pattern of the voltage, frequency, or rotor phase angle.

According to one example, the algorithm 1908 may determine the probability of failure by comparing the power signal characteristics from step 1906 with known utility grid stability parameters. The algorithm may obtain the known utility grid stability parameters in a number of different ways. In one example, the known utility grid stability parameters may be obtained by accessing a memory device where the known utility grid stability parameters are stored. In another example, the algorithm may determine the known utility grid stability parameters by performing a self-learning function using collected data over a period of time. In yet another example, the known utility grid stability parameters may be obtained by the algorithm in the form of electric utility power grid stability characteristics 1910. The utility grid stability parameters 1910 may be obtained from one or more of, but not limited to: the electric utility company, electric utility based research, self-learning based on historical data collected by the system and regulatory agencies. A power regulation algorithm may be developed based on the utility grid power stability parameters. The algorithm development may include adding weighting factors based on the utility grid power stability parameters.

Returning to method 1900, after step 1908, the method proceeds to step 1910 where the utility power grid stability is classified. The method can assign one of any number of classifications to the utility grid. For example, the classification can be one of normal condition 2010, unstable horizon condition 2012, chaotic horizon condition 2014, or grid failure horizon condition 2016.

At step 1912, the energy savings device 1 may regulate the energy received from electric utility power grid 1830 based on the classification from step 1910. According to one example, the energy savings devices 1 may regulate power or energy demand based on similar criteria. Alternatively, the energy savings devices 1 may regulate power or energy demand based on different criteria. In other words, energy savings devices 1 located in a same region may be customized to regulate power and energy in a same or different manner, as desired. A modification of power demand may include one or more of changing voltage and changing an amount of power demand. As the probability of a grid failure increases, the method may locally reduce the incoming line voltage, thus reducing the power drawn from the utility grid and limiting power that the customer can demand, as demonstrated in equation (1).

Through empirical measurements, electric utilities have concluded that a one volt reduction in grid voltage may reduce the grid power by approximately 1%. By installing the energy savings device 1 in a plurality of residences and businesses connected to the utility grid, the method 1900 may autonomously reduce the power demand at each premises when instabilities of the utility grid are detected. This instantaneous reduction in power demand over a plurality of energy savings devices 1 may enhance power grid stability, thereby improving the reliability of electric power delivery. Accordingly, the system and method may eliminate brown-outs, rolling black-outs, and complete power grid failure when the energy savings device 1 senses the onset of non-normal conditions. After step 1912, the method continues to step 1914 where it resumes previous processing, including repeating method 1900.

Returning to FIG. 20 a chart is illustrated with a curve that relates an incoming energy level to electric utility grid stability. The curve may be estimated by applying the power regulation algorithm to the at least one probability of failure. The ranges of electric utility grid stability may be defined by the statistical analysis, empirical analysis, or provided by a third party (regulatory agency, electric utility, etc.). In some embodiments, the statistical and/or empirical analysis may be performed by an analysis program on energy savings device 1 and/or medium 1810. If the probability of failure algorithm produces a probability of network failure in the normal horizon condition 2010 category, then the power regulation algorithm may cause energy savings device 1 to continue to provide power equal to the demand. If the probability of failure algorithm produces a value in the unstable horizon condition 2012 category, then the power regulation algorithm may cause the energy savings device 1 to reduce the demand power. In some embodiments, the demand for power reduction may be linear within the unstable horizon condition 2012 category. If the probability of failure algorithm produces a value in the chaotic horizon condition 2014 category, the power regulation algorithm may cause energy savings device 1 to reduce demand power further. In some embodiments, the demand power reduction slope is greater in the chaotic horizon condition 2014 category than in the unstable horizon condition 2012 category.

If the probability of failure algorithm produces a value in the grid failure horizon condition 2016 category, then the power regulation algorithm may cause energy savings device 1 to reduce the power demand to zero. The microprocessor 1820 may continuously monitor grid stability data to determine when demand power may be restored to the premises after reduction of demand power to zero. Accordingly, the energy savings device 1 determines the stability condition of the electric grid and may automatically turn off power at the point of consumption if a determination is made that a probability of electric grid failure is eminent. According to one example, the energy savings device 1 may turn off power at the point of consumption before the electric grid fails. However, if the electric grid fails, the energy savings device 1 may automatically assert grid failure.

In some embodiments, demand power from energy savings device 1 is not restored as soon as the probability of failure returns to the normal horizon condition 2010 category. If all of premises demanded restored power simultaneously, then the electric utility grid may become overwhelmed and return to an unstable state or a failure state. To mitigate the risk of a repeat failure, the energy savings device 1 may be instructed by the microprocessor 1820 to execute the program and to restore power based on a randomly generated number between 0 and 1 that is multiplied by a “Regional Resume” time to create a “Premise Resume Time, as follows:

t_{premise resume}=t_{regional resume}×RND (6)

FIG. 21 shows a graph of homes restored versus time using the randomly generated restore time. The energy savings device 1 may resume power once the Premise Resume Time, t_{premise resume} has expired as long the stability remains in the normal horizon condition 2010 category. This allows for an autonomous grid soft start to further assist the power grid utility to maintain stability as the power is resumed in the grid. Some end customers will immediately resume power, while other end customers may take several tens of seconds to have power restored. The t_{regional resume} may be a value provided by the power grid utility for a specific grid and may represent a total elapsed time to restore power to the whole grid. The random number multiplication of eqn. (6) may restore the load in a relatively smooth fashion, even though different premises will have different power demands when their power is restored. A maximum amount of time for restoring power to an end user after the power grid is determined to be stable may be pre-determined by an electric utility. The maximum amount of time may be pre-set into the energy savings device 1 at a manufacturing facility and may be modified during or after installation. Alternatively, the maximum amount of time may be communicated to the energy savings device 1 over a communications channel. The maximum value may be multiplied by a random number between 0 and 1, for example, and may be calculated at a time of power restoration. According to one example, a product of these two numbers may represent a length of time the energy savings device 1 may delay turning on electric power to the end customer.

While the disclosure has been described with reference to exemplary embodiments, it will be understood that various changes may be made and equivalents may be substituted for elements thereof without departing from the scope of the disclosure. In addition, many modifications will be appreciated to adapt a particular instrument, situation or material to the teachings of the disclosure without departing from the essential scope thereof. Therefore, it is intended that the disclosure not be limited to the particular embodiment disclosed or the best mode contemplated for carrying out this disclosure, but that the disclosure will include all embodiments falling within the scope of the appended claims.

What is claimed is:

1. A method of reducing power demand on a utility grid at a point of consumption, the method comprising:
monitoring a power signal characteristic;
obtaining a stability parameter for the utility grid;
determining a stability condition based on the monitored power signal characteristic and the stability parameter; and
regulating, at the point of consumption, an amount of energy received from the utility grid based on the determined stability condition.

2. The method of claim 1, wherein the power signal characteristic includes at least one of a voltage, a frequency, and a rotor angle.

3. The method of claim 1, wherein the stability parameter corresponds to pre-determined conditions.

4. The method of claim 1, wherein the stability condition includes at least one of a normal condition, an unstable condition, a chaotic condition, and a grid failure condition.

5. The method of claim 4, wherein the amount of energy obtained from the utility grid is regulated to be substantially unchanged during the normal condition.

6. The method of claim 4, wherein the amount of energy obtained from the utility grid is regulated to be reduced by a first amount during the unstable condition and reduced by a second amount during the chaotic condition, the second amount being greater than the first amount.

7. The method of claim 4, wherein the amount of energy obtained from the utility grid is regulated to zero during the grid failure condition and the method further comprises:
monitoring the power signal characteristic after the amount of energy is regulated to zero;
determining a restart stability condition based on the monitored power signal characteristic and the stability parameter; and
initiating a restore operation at a pre-determined amount of time based on the determined restart stability condition.

8. A system for reducing power demand on a utility grid at a point of consumption, the system comprising:
a memory; and
a processor that communicates with the memory having instructions stored thereon that, when executed by the processor, cause the system to:
monitor a power signal characteristic;
obtain a stability parameter for the utility grid;
determine a stability condition based on the monitored power signal characteristic and the stability parameter; and
regulate, at the point of consumption, an amount of energy received from the utility grid based on the determined stability condition.

9. The system of claim 8, wherein the power signal characteristic includes at least one of a voltage, a frequency, and a rotor angle.

10. The system of claim 8, wherein the stability parameter corresponds to pre-determined conditions.

11. The system of claim 8, wherein the stability condition includes at least one of a normal condition, an unstable condition, a chaotic condition, and a grid failure condition.

12. The system of claim 11, wherein the amount of energy obtained from the utility grid is regulated to be substantially unchanged during the normal condition.

13. The system of claim 11, wherein the amount of energy obtained from the utility grid is regulated to be reduced by a first amount during the unstable condition and reduced by a second amount during the chaotic condition, the second amount being greater than the first amount.

14. The system of claim 11, wherein the amount of energy obtained from the utility grid is regulated to zero during the grid failure condition and the processor executes instructions to cause the system to:
monitor the power signal characteristic after the amount of energy is regulated to zero;
determine a restart stability condition based on the monitored power signal characteristic and the stability parameter; and
initiate a restore operation at a pre-determined amount of time based on the determined restart stability condition.

15. A non-transitory computer-readable storage medium having stored therein instructions which, when executed by a processor, cause an electronic device to:
monitor a power signal characteristic;
obtain a stability parameter for the utility grid;
determine a stability condition based on the monitored power signal characteristic and the stability parameter; and
regulate, at the point of consumption, an amount of energy received from the utility grid based on the determined stability condition.

16. The non-transitory computer-readable storage medium of claim 15, wherein the power signal characteristic includes at least one of a voltage, a frequency, and a rotor angle.

17. The non-transitory computer-readable storage medium of claim 15, wherein the stability parameter corresponds to pre-determined conditions.

18. The non-transitory computer-readable storage medium of claim 15, wherein the stability condition includes at least one of a normal condition, an unstable condition, a chaotic condition, and a grid failure condition.

19. The non-transitory computer-readable storage medium of claim 18, wherein the amount of energy obtained from the utility grid is regulated to be substantially unchanged during the normal condition.

20. The non-transitory computer-readable storage medium of claim 1, wherein the amount of energy obtained from the utility grid is regulated to be reduced by a first amount during the unstable condition and reduced by a second amount during the chaotic condition, the second amount being greater than the first amount.
